(19) United States
(12) Patent Application Publication
(10) Pub. No.: US 2012/0110742 A1
(43) Pub. Date: May 10, 2012

(54) SUPPORT DEVICE FOR SUPPORTING A PART OF THE BODY OF A SUBJECT ON A SUPPORT PLATFORM, AND A KIT OF PARTS AND A METHOD FOR SUPPORTIING A SUBJECT IN A SUPINE STATE ON A SUPPORT PLATFORM

(75) Inventors: Michael John Lawler, County Kildare (IE); Noel Anthony Muldowney, County Kildare (IE)

(73) Assignee: VASOCARE PATENT LIMITED, Carlow (IE)

(21) Appl. No.: 13/383,501

(22) PCT Filed: Jul. 13, 2010
(86) PCT No.: PCT/IE10/00041

§ 371 Date: Jan. 11, 2012

(30) Foreign Application Priority Data
Jul. 13, 2009 (IE) S2009/0534

(51) Int. Cl. A61G 13/12; A47G 9/10

(52) U.S. Cl. 5/632; 5/630; 5/636; 5/647; 5/648; 5/638

(57) ABSTRACT

A kit of parts for supporting a subject on an operating table comprises head, arm, leg, foot and trunk support devices (5 to 9). The head support device (5) comprises a central support element (12) and a neck support element (17) for supporting the back of the head and neck, respectively, of the subject, and primary and secondary side members (22,23) for engaging and supporting the sides of the head and neck, respectively, of a subject. First and second platform engaging elements (20,21) extend downwardly from the central support element (12) for supporting the central support element (12) spaced apart above the operating table. A resiliently deformable strengthening member (25) extends through the neck support element (17) between the first platform engaging elements (20) and co-operates with the central support element (12) and the neck support element (17) for urging the primary and secondary side members (22,23) into engagement with the sides of the head and neck of the subject when the head support device (5) is in a loaded state. The resilience of the strengthening member (25) is such that as soon as the load is removed, the strengthening member (25) co-operates with the central support element (12) and the neck engaging element (17) to urge the primary and secondary side members (22,23) outwardly substantially instantaneously to thereby return the head support device (5) to its unloaded state. Each of the arm, leg, foot and trunk support devices (6 to 9) operate in a substantially similar manner.

The present invention relates to a support device for supporting a part of the body of a subject on a support platform. The invention also relates to a kit of parts for supporting a subject in a supine state on a support platform, and the invention also relates to a method for supporting a subject in a supine state on a support platform.

It is important when a subject is being supported on a support platform, for example, a surgical operating table, a stretcher or other such platform for any reasonably lengthy period, that the subject should be supported so that the weight of the subject is distributed as evenly as possible over the portions of body of the subject which are supported on the support platform. In particular, it is important that parts of the body which are supported on the support platform are not subjected to excessive pressures. Localised excessive pressures on local areas of the body can rapidly result in the onset of pressure sores adjacent such locations. This is undesirable. In order to minimise localised areas of the body being subjected to excessive pressures, it is important that the area of contact of the body which is bearing the load of the body on a support platform is maximised. Cushions, mattresses and the like have been used on support platforms for maximising the area of contact of the body over which the load can be distributed. However, such cushions and mattresses suffer from a number of disadvantages, for example, such cushions and mattresses are unsuitable for use in an operating theatre, since they are difficult and in many cases impossible to properly disinfect. Such cushions and mattresses also result in bony prominences of the body of the subject being subjected to excessive pressure, which results in the development of pressure sores adjacent such bony prominences. Such cushions and mattresses may also result in heat being conducted from the subject in the areas of contact between the body of the subject and the cushion or mattress. This is undesirable.

There is therefore a need for a support device for supporting a part of the body of a subject on a support platform which maximises the area of contact of the body over which the weight of the body is distributed.

The present invention is directed towards providing such a support device, and the invention is also directed towards providing a kit of parts for maximising the area of contact of the body over which the weight of the body is distributed when lying in a supine state on a support platform. The invention is also directed towards a method for supporting a subject in a supine state on a support platform which maximises the area of contact of the subject over which the weight of the body is distributed.

According to the invention there is provided a support device for supporting a part of the body of a subject on a support platform, the support device comprising a central support element for supporting the part of the body, the central support element located between opposite raised side support elements, at least one pair of first platform engaging elements extending downwardly on opposite sides of the central support element for supporting the central support element spaced apart above the platform when the support device is in an unloaded state, and an elongated resiliently deformable strengthening member located in and extending transversely of the central support element between the first platform engaging elements, the strengthening member co-operating with the central support element and the side support elements for urging the side support elements into engagement with respective adjacent portions of the part of the body supported on the central support element when the support device is in a loaded state with the central support element deflected downwardly between the first platform engaging elements by the weight of the part of the body supported thereon and for returning the support device to the unloaded state when the load is removed therefrom.

Preferably, the side support elements are adapted to engage and support the respective adjacent portions of the part of the body supported by the central support element.

Advantageously, the side support elements are adapted to engage the adjacent portions of the part of the body supported on the central support element so that the part of the body is substantially embraced by the central and side support elements.

In one embodiment of the invention the first platform engaging elements and the central support element define a concave surface when viewed from underneath. Preferably, the first platform engaging elements extend downwardly from the central support element beneath the side support elements.

In another embodiment of the invention the central support element is dished when viewed in plan from above. Preferably, the side support elements and the central support element define a concave surface when viewed from above.

In one embodiment of the invention the central support element extends longitudinally between a first end and a spaced apart second end, the first platform engaging elements being located adjacent the first end of the central support element.

Advantageously, the strengthening member is located adjacent the first end of the central support element.

In another embodiment of the invention at least one second platform engaging element extends downwardly from the central support element adjacent the second end thereof. Preferably, a pair of the second platform engaging elements extend downwardly at opposite sides of the central support element adjacent the second end thereof.

In one aspect of the invention a pair of the strengthening members are provided, a second one of the strengthening members being located adjacent the second end of the central support element and extending transversely thereof between the second platform engaging elements. Preferably, each strengthening member co-operates with the corresponding pair of platform engaging elements for urging the side support elements into engagement with the respective opposite sides of the part of the body supported on the central support element when the support device is in the loaded state.

Advantageously, the resilience of each strengthening member is such as to substantially instantaneously return the support device to its unloaded state once a load has been removed therefrom.

In one aspect of the invention each strengthening member is of arcuate transverse cross-section.

In another aspect of the invention the transverse cross-section of each strengthening member defines a segment of a circle. Preferably, the segment of the circle defined by the transverse cross-section of each strengthening member extends an angular distance in the range of 90° to 130°. Advantageously, the segment of the circle defined by the transverse cross-section of each strengthening member extends an angular distance in the range of 100° to 110°. Ideally, the segment of the circle defined by the transverse cross-section of each strengthening member extends an angular distance of approximately 104°.

Preferably, each strengthening member is located in the central support element with the transverse cross-section thereof concave when viewed in plan from above.

Advantageously, each strengthening member is of a plastics material.

In another aspect of the invention the flexural strength of each strengthening member lies in the range of 3 Newton load to 15 Newton load. Preferably, the flexural strength of each strengthening member lies in the range of 5 Newton load to 10 Newton load. Advantageously, the flexural strength of each strengthening member lies substantially in the order of 5.5 Newton load.

Preferably, each strengthening member is embedded in the central support element.

In another embodiment of the invention an air accommodating opening is provided extending through the central support element to accommodate air to a portion of the part of the body of the subject supported thereon. Preferably, the air accommodating opening is adapted to accommodate a bony prominence extending from the part of the body supported on the central support element.

In another aspect of the invention the central and side support elements and the platform engaging elements are of a resilient material.

In a further aspect of the invention the central support element is of layered construction comprising a first layer of a first resilient material, and a second layer of a second resilient material, the second layer supporting the first layer, and being of Shore hardness greater than the Shore hardness of the first layer. Preferably, each strengthening member is located adjacent a boundary between the first layer and the second layer.

Advantageously, the side support elements are of layered construction, with the first and second resilient materials of the respective first and second layers of the central support element extending into and forming the side support elements. Preferably, each platform engaging element comprises the second resilient material, a portion of which extends from the second layer of the central support element to form the corresponding platform engaging element. Ideally, respective opposite ends of the strengthening member extend into the second resilient material of the adjacent platform engaging elements and are embedded therein.

In one embodiment of the invention the first resilient material is malleable. Preferably, the first resilient material of the first layer is adapted to follow the contours of the part of the body of the subject adjacent thereto. Advantageously, the Shore hardness of the first resilient material lies in the range of 20 Shore 00 to 70 Shore 00. Preferably, the Shore hardness of the first resilient material lies in the range of 50 Shore 00 to 60 Shore 00. Ideally, the Shore hardness of the first resilient material is approximately 55 Shore 00.

In another embodiment of the invention the Shore hardness of the second resilient material lies in the range of 70 Shore 00 to 99 Shore 00. Preferably, the Shore hardness of the second resilient material lies in the range of 70 Shore 00 to 80 Shore 00. Advantageously, the Shore hardness of the second resilient material is approximately 75 Shore 00.

Preferably, a third layer of a third resilient material is coated over exposed surfaces of the first layer. Advantageously, the third layer of the third resilient material is coated over exposed surfaces of the second layer. Ideally, the Shore hardness of the third resilient material is less than the Shore hardness of the first resilient material.

In one aspect of the invention the Shore hardness of the third resilient material lies in to the range of 10 Shore A to 50 Shore A. Advantageously, the Shore hardness of the third resilient material lies in the range of 10 Shore A to 20 Shore A. Ideally, the Shore hardness of the third resilient material is approximately 10 Shore A.

In one aspect of the invention the central support element is adapted to support the back of the head of a subject lying in a supine state, the central support element terminating adjacent the first end in a raised end support element for supporting the back of the neck of a subject, respective portions of the side support elements adjacent the second end of the central support element forming primary side members for engaging opposite sides of the head of the subject, the strengthening member being located in the central support element adjacent the end support element and co-operating with the side support elements adjacent the first end of the central support element for urging the side support elements adjacent the end support element into engagement with respective opposite sides of the neck of the subject when the support device is in the loaded state-supporting the head and neck of the subject.

Preferably, the strengthening member co-operates with the primary side members for urging the primary side members into engagement with respective opposite sides of the head of the subject when the support device is in the loaded state. In another aspect of the invention a crown support member extends upwardly from the central support element adjacent the second end thereof for abutting and engaging the crown of the head of a subject. Preferably, the central support element co-operates with the crown support member for urging the crown support member into abutting engagement with the crown of the subject when the support device is in the loaded state.

In another aspect of the invention the central support element is adapted for supporting an arm of the subject, and a pair of the strengthening members are located in the central support element towards respective first and second ends thereof. Preferably, a retaining means is provided for retaining an arm of the subject therein. Advantageously, the retaining means comprises a retaining strap releasably coupleable with the support device.

In another aspect of the invention at least one securing means is provided for securing the support device to the support platform. Preferably, the at least one securing means is releasably coupleable to the support device. Advantageously, the securing means comprises a securing strap coupleable to the support device.

In a further aspect of the invention the central support element is adapted for supporting a foot of the subject adjacent the heel thereof, the first end of the central support element being adapted to engage a leg of the subject adjacent the ankles thereof. Preferably, the side support elements are adapted for engaging the ankles of the leg of the subject when the support device is in the loaded state supporting the foot of the subject. Advantageously, a foot engaging member extends upwardly from the second end of the central platform for engaging the sole of the foot of the subject, the foot engaging member co-operating with the central support element and the first and second platform engaging elements for urging the foot engaging member into engagement with the foot of the subject when the support device is in the loaded state with the foot of the subject supported therein.

In a still further aspect of the invention the central support element is adapted for supporting a leg of a subject at a location behind the knee thereof.

In another aspect of the invention the support device is adapted for supporting a portion of the trunk of the body of a subject, the central support element and one of the side support elements being adapted for supporting a portion of the trunk of the subject between the spine of the subject and a side of the subject, and the other side support element being adapted for engaging the adjacent side of the trunk of the subject.

The invention also provides a support device for supporting a part of the body of a subject, the support device comprising a central support element extending between a first end and a second end, and extending between a pair of raised side support elements located on opposite sides of the central support element, the central support element terminating adjacent the first end thereof in an end support element, a pair of spaced apart first platform engaging elements extending downwardly from the end support element, and at least one second platform engaging element extending downwardly from the central support element adjacent the second end thereof, the central support element and the end support element being of resilient material and co-operating with the side support elements for urging the side support elements into engagement with respective adjacent portions of the part of the body supported by the central support element when the support device is in a loaded state with the part of the body of the subject supported on the central support element and the end support element, and for returning the support device to the unloaded state when the load is removed therefrom.

Preferably, at least one primary support member extends upwardly from the central support element adjacent the second end thereof, and the central support element is co-operable with the at least one primary side member for urging the primary side member into engagement with an adjacent portion of the part of the body when the support device is in a loaded state with the part of the body supported on the central and end support elements. Advantageously, a pair of the primary side members are provided on respective opposite sides of the central support element adjacent the second end thereof.

In one embodiment of the invention a pair of second platform engaging elements extend downwardly from the central support element adjacent the second end thereof.

In another aspect of the invention the central support element co-operates with the platform engaging elements for urging each primary side member into engagement with the adjacent portion of the part of the body when the support device is in the loaded state.

In a further aspect of the invention the end support element co-operates with the platform engaging elements for urging the side support elements into engagement with the adjacent portions of the part of the body. Preferably, the opposite side support elements are located adjacent the end support element.

In another embodiment of the invention an elongated resiliently deformable strengthening member is located in the end support element and extends transversely of the central support element between the first platform engaging elements, the strengthening member co-operating with the end support element for urging the side support elements into the adjacent portions of the part of the body when the support device is in the loaded state, and for returning the support device to the unloaded state when the load is removed. Preferably, the strengthening member is of arcuate transverse cross-section.

In another aspect of the invention the strengthening member is located in the end support element with the transverse cross-section thereof concave when viewed in plan from above. Preferably, the strengthening member is of a plastics material.

In another aspect of the invention the platform engaging elements and the central support element define a concave surface when viewed from underneath. Preferably, the platform engaging elements extend downwardly from the central support element beneath the side support elements.

In another aspect of the invention the central support element is dished when viewed in plan from above. Preferably, the side support elements and the central support element define a concave surface when viewed from above.

Additionally, the invention provides a head support device for supporting the head of a subject in a supine state, the head support device comprising a central support element for supporting the back of the head of the subject, the central support element extending between a first end and a spaced apart second end, and terminating adjacent the first end in an end support element for supporting the neck of the subject, a pair of spaced apart side support elements located on respective opposite sides of the central support element adjacent the end support element, a pair of spaced apart primary side members extending upwardly from the central support element adjacent opposite sides thereof adjacent the second end of the central support element for engaging opposite sides of the head of the subject, a pair of first platform engaging elements located on opposite sides of the central support element adjacent the end support element and extending downwardly therefrom and at least one second platform support element extending downwardly from the central support element adjacent the second end thereof, the first and second platform engaging elements co-operating for supporting the central support element and the end support element spaced apart above the support platform, the central support element being of a resiliently deformable material and co-operating with the platform engaging elements and the primary side members so that downward movement of the central support element in response to the support device being in a loaded state with the head supported on the central support element urges the primary side members into engagement with the respective sides of the head, and on unloading of the support device the support device is returned to its unloaded state.

Preferably, the end support element is of a resiliently deformable material and co-operates with the side support elements and the first platform engaging elements for urging the side support elements into engagement with opposite sides of the neck of the subject in response to downward movement of the end support element when the support device is in the loaded state with the neck supported on the end engaging element, and for returning the support device to its unloaded state on removal of the load therefrom.

Preferably, the side support elements and the platform engaging elements are of resiliently deformable material.

In another aspect of the invention an elongated resiliently deformable strengthening member located in the end support element extending in a general direction between the first platform engaging elements for returning the support device to the unloaded state when the load of the head is removed therefrom. Preferably, the strengthening member is embedded in the end support element. Advantageously, the strengthening member extends from one of the first platform engaging elements and the other of the platform engaging elements. In one aspect of the invention the strengthening member co-operates with the end support element and the side support elements for urging the side support elements into engagement with the opposite sides of the neck on loading of the support device with the neck of the subject supported on the end support element. Preferably, the strengthening member co-operates with the first platform engaging element for urging the side support elements into engagement with the opposite sides of the neck on loading of the support device with the neck of the subject supported in the support element.

In another aspect of the invention the strengthening member is of arcuate transverse cross-section.

Further the invention provides a kit of parts for supporting a subject in a supine state on a support platform, the kit of parts comprising the head support device according to the invention.

Preferably, the kit of parts further comprises an arm support device, the arm support device comprising an elongated central support element extending between a first end and a second end and between a pair of opposite spaced apart raised side support elements, a pair of spaced apart first platform engaging elements extending downwardly on respective opposite sides of the central support element towards the first end thereof, and a pair of spaced apart second platform engaging elements extending downwardly on respective opposite sides of the central support element towards the second end thereof, and at least one elongated resiliently deformable strengthening member located in and extending transversely of the central support element between the first platform engaging elements, the strengthening member co-operating with the central support element and the side support elements for urging the side support elements into engagement with respective opposite sides of an arm of the subject when the support device is in a loaded state with the central support element supporting the arm and for returning the support device to an unloaded state when the load is removed therefrom.

Preferably, a pair of arm support devices are provided.

In another embodiment of the invention the kit of parts further comprises a foot support device comprising a central support element extending between a first end and a second end, and a pair of raised side support elements located on respective opposite sides of the central support element, an end support element located adjacent the first end of the central support element for engaging a leg of the subject adjacent the ankle thereof with the heel of the foot of the subject supported on the central support element, a pair of spaced apart first platform engaging elements extending downwardly from the central support element adjacent the end support element, and an elongated resiliently deformable strengthening member located in the end support element extending transversely of the central support element between the first platform engaging elements, the strengthening member co-operating with the end support element and the side support elements for urging the side support elements into engagement with respective ankles of the leg of the subject when the foot support element is in a loaded state supporting a foot of the subject and for returning the support device to an unloaded state when the load is removed therefrom.

Preferably, a pair of foot support devices are provided.

In a still further embodiment of the invention the kit of parts further comprises a leg support device for supporting a leg of the subject adjacent the back of the knee thereof on the support platform, the leg support device comprising a central support element extending between a first end and a second end and between respective raised side support elements on respective opposite sides of the central support element, a pair of spaced apart first platform engaging elements extending downwardly from the central support element adjacent opposite sides thereof adjacent the first end thereof beneath the side support elements, and a pair of second platform engaging elements extending downwardly from the central support element adjacent opposite sides thereof adjacent the second end thereof, and an elongated resiliently deformable strengthening member located in and extending transversely of the central support element between the platform engaging elements, the strengthening member co-operating with the central support element and the side support elements for urging the side support elements into engagement with respective opposite sides of the leg of the subject adjacent the knee thereof when the leg support device is in a loaded state supporting the part of the leg and for returning the support device to the unloaded state when the load is removed therefrom.

Preferably, a pair of leg support devices are provided.

In another embodiment of the invention the kit of parts further comprises a trunk support device for supporting a part of the trunk of the body of the subject on the support platform, the trunk support device comprising a central support element extending between a first end and a second end and between respective opposite raised side support elements on respective opposite sides of the central support element, a pair of spaced apart platform engaging elements extending downwardly from the central support element on respective sides thereof, and an elongated resiliently deformable strengthening member located in and extending transversely of the central support element between the platform engaging elements, the strengthening member co-operating with the central support element and the side support elements for urging one of the side support elements into engagement with the back of the trunk between the spine of the trunk and one side thereof, and the other side support element into engagement with the adjacent side of the trunk when the support device is in a loaded state with a portion of the back of the trunk between the spine and the said side of the trunk supported on the central support element, and for returning the support device to the unloaded state when the load is removed therefrom.

Preferably, a pair of trunk support devices are provided.

In another aspect of the invention each strengthening member of each support device is of arcuate transverse cross-section. Advantageously, the transverse cross-section of each strengthening member defines a segment of a circle.

Further the invention provides a kit of parts for supporting a subject in a supine state on a support platform, the kit of parts comprising a plurality of the support devices according to the invention. In one aspect of the invention one of the support devices is configured to support the head and neck of a subject.

In another aspect of the invention two of the support devices are configured to support the feet of the subject.

In another aspect of the invention two of the support devices are configured to support the legs of the subject adjacent the knees thereof.

In a further aspect of the invention two of the support devices are configured to support the arms of the subject.

In a further aspect of the invention two of the support devices are configured to support the trunk of the subject.

The invention also provides a method for supporting a subject on a support platform comprising placing the respective support devices of the kit of parts according to the invention on the platform with the platform engaging elements engaging the platform, and placing the head of the subject in the head support device with the back of the head resting on the central support element and the neck of the subject resting on the first end support element, placing the trunk support devices under the back of the subject with the trunk support devices supporting the back of the subject on respective opposite sides thereof, placing the leg support devices beneath the legs of the subject behind the knees thereof, placing the foot support devices beneath the respective heel bones of the subject with the heel bone of the subject supported on the respective central support elements of the foot support devices, placing the arm support devices beneath the arms of the subject with the arms supported on the central support elements of the arm support devices.

Preferably, the arm support devices are secured to the support platform and the retaining means are secured to the arm support devices for retaining the arms of the subject therein.

The advantages of the invention are many. The support devices according to the invention minimise the risk of pressure sores developing on a subject, and in general, completely avoid the development of pressure sores. This advantage is largely achieved by virtue of the fact that the support devices according to the invention increase the area of contact of a part of the body being supported, and thus increase the area over which the weight of that part of the body being supported is distributed. Additionally, the provision of the air accommodating opening in the central support element of the support devices provides clearance for a bony prominence of the part of the body being supported, thereby avoiding localised high pressure points on such bony prominences, and in turn minimises the risk of pressure sores developing. Additionally, the provision of the air accommodating opening in the central support element allows for circulation of air around the part of the body exposed by the opening which in turn further reduces and effectively eliminates the risk of the development of pressure sores on such exposed parts of the body. The provision of the air accommodating openings also avoids the build-up of moisture around the bony prominences, and this further acts to minimise the possibility of the development of pressure sores. By providing the kit of parts to be of a plastics material, heat transfer between the subject and the devices of the kit of parts is minimised, and therefore heat lost from the subject to the devices of the kit of parts is minimised.

By providing the support devices according to the invention with a first layer of resilient material which is a relatively malleable resilient material allows the surface of the support device to substantially follow the broader contours of the skin of the subject engaged by the support device. This further increases the area of contact of the part of the body being supported and thereby further increases the area of the part of the body being supported over which the load of the part of the body is distributed. This, thus, reduces the pressure on the parts of the body being supported and furthermore, and most importantly, minimises the risk of localised areas of high pressure.

A particularly important advantage of the invention is achieved by the provision of the elongated resiliently deformable strengthening member, in that on the load being removed from the support device, the strengthening member by co-operating with the central support element, the platform engaging elements and the side support elements virtually instantaneously returns the support device to its unloaded state on the load being removed. This is a particularly important advantage in busy operating theatres and in busy accident and emergency departments of hospitals, since as soon as the support device has been removed from one patient, it is immediately ready for use with another patient. Therefore, there is no delay between transferring one patient from an operating table or other support platform, and transferring the next patient onto the operating table or support platform, where the same support elements are being used for supporting both patients. This has been a problem where support devices known heretofore have been used for supporting a part of a body of a subject on an operating table, where in many cases considerable delays have been experienced as a result of the delay in such support devices returning to their normal unloaded state once a load has been removed therefrom. Many support devices known heretofore can take up to one hour to return to their normal unloaded state after a load has been removed therefrom.

A further additional advantage of the invention is that by providing the air accommodating openings in the central support elements of the support devices, pressure on bony prominences of the subject is substantially eliminated, thereby further minimising the development of pressure sores on such bony prominences. Additionally, the provision of the air accommodating openings facilitate air circulation around such bony prominences and areas of the body of the subject exposed by the air accommodating openings, thereby further minimising the development of pressure sores on such areas.

It has also been found that the provision of the air accommodating opening in the devices of the kit of parts avoids any alteration of blood flow in the body of the subject adjacent the air accommodating opening. This, thus, allows normal blood flow to continue while the subject is supported on the support devices of the kit of parts. Alteration of normal blood flow has been a problem in devices known heretofore, in particular alteration of normal blood flow in areas which are subjected to excessive pressure. In such cases where normal blood flow is altered, it can take quite some time, and in many cases, up to twenty minutes, for normal blood flow to be re-established in the body after the subject has been removed from support devices known heretofore. The provision of the air circulating opening in the head support device has been found to assist in the prevention of the development of pressure alopecia. Due to the immersing effect of the support devices according to the invention, the occurrence of sheer forces on bony prominences is eliminated.

The advantages of use of the kit of parts according to the invention are similar to those achieved by using the individual parts thereof. Similar advantages are achieved by use of the method according to the invention for supporting a subject on a support platform.

The invention will be more clearly understood from the following description of some preferred embodiments thereof, which are given by way of example only, with reference to the accompanying drawings, in which:

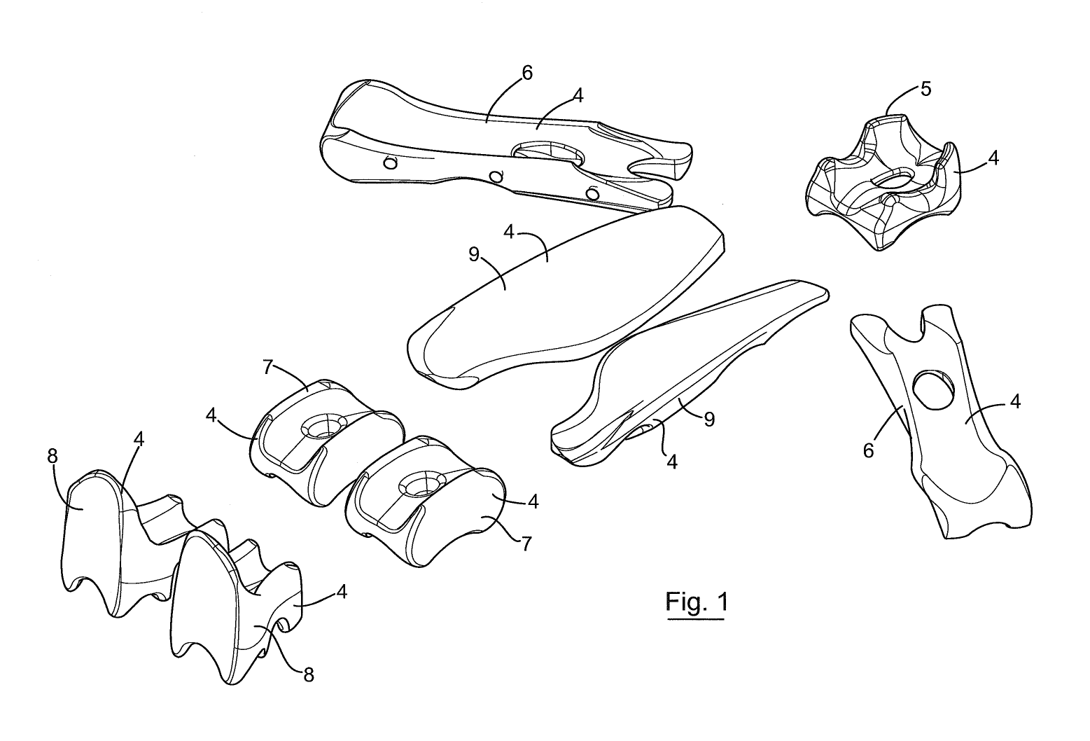

FIG. 1 is a perspective view of a kit of parts according to the invention for supporting a subject on an operating table,

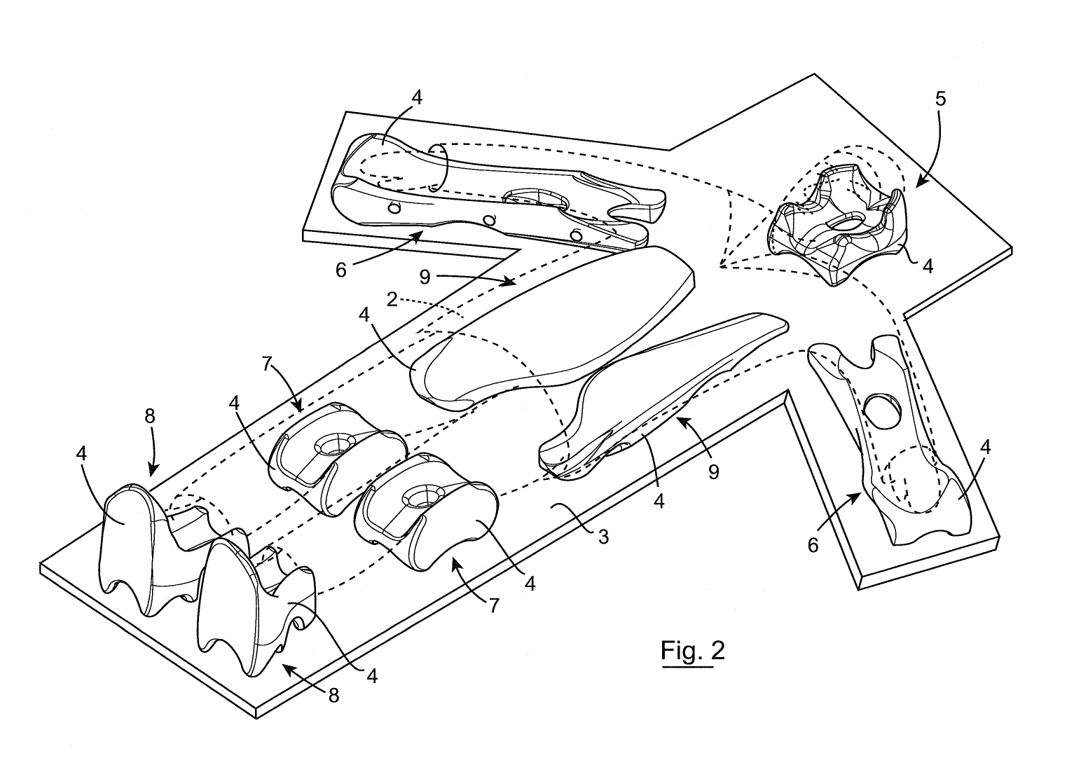

FIG. 2 is a perspective view of the kit of parts of FIG. 1 in use,

FIG. 3 is a perspective view of a head support device of the kit of parts of FIG. 1,

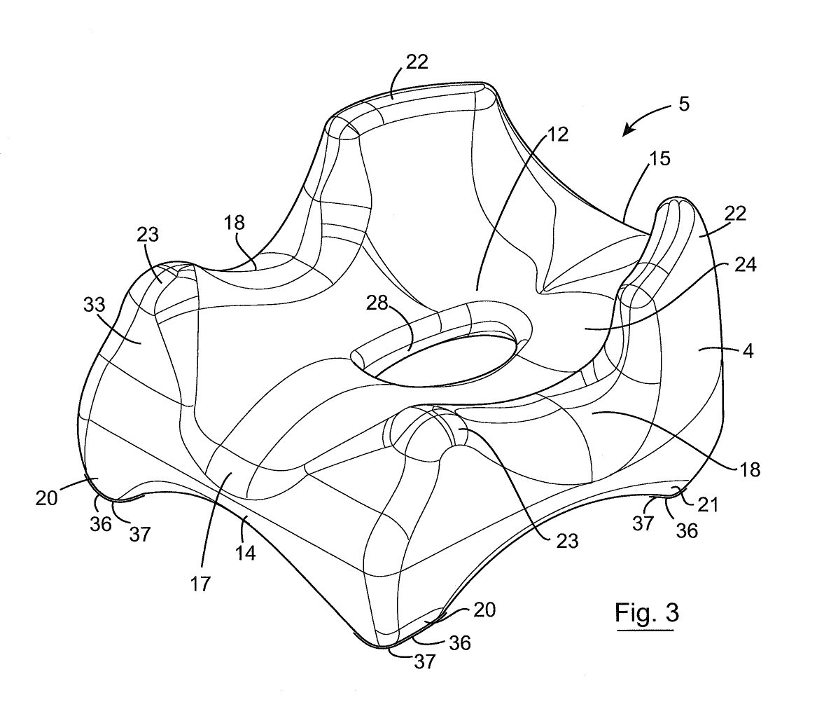

FIG. 4 is a partly cutaway cross-sectional perspective view of the head support device of FIG. 3,

FIG. 5 is a transverse cross-sectional view of the head support device of FIG. 3,

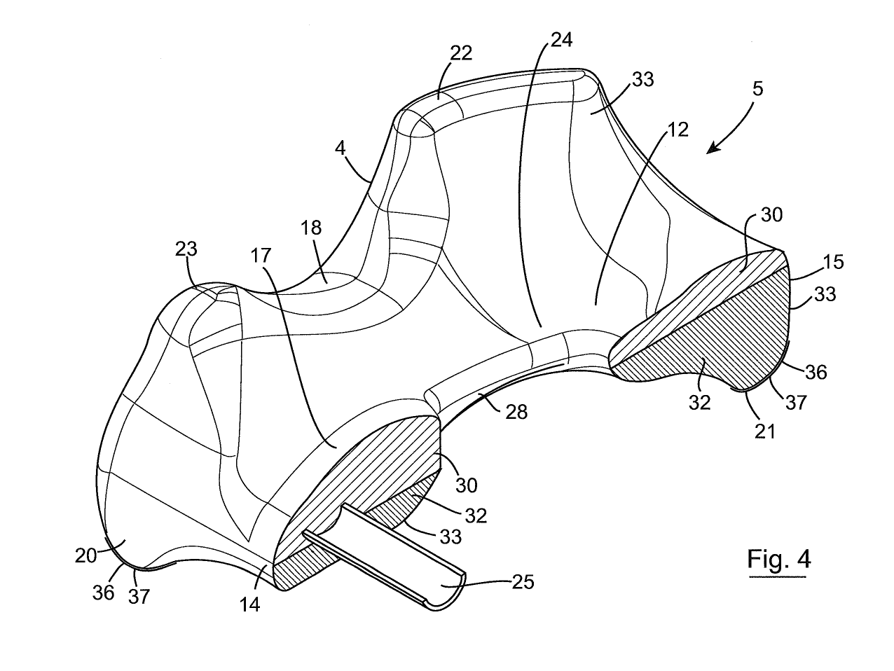

FIG. 6 is a view similar to FIG. 5 illustrating the head support device of FIG. 3 in use,

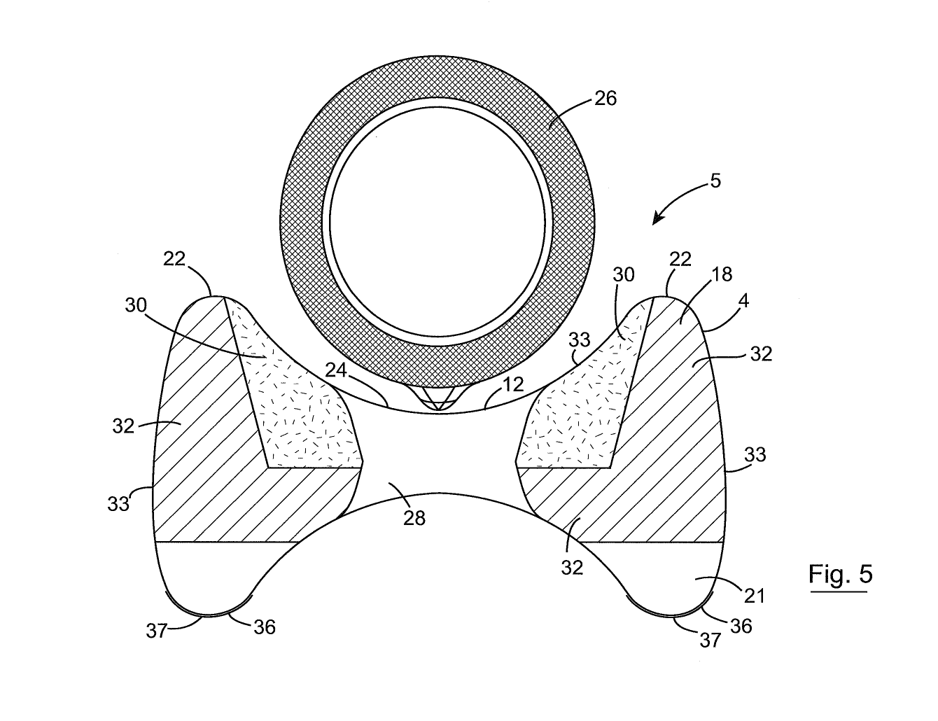

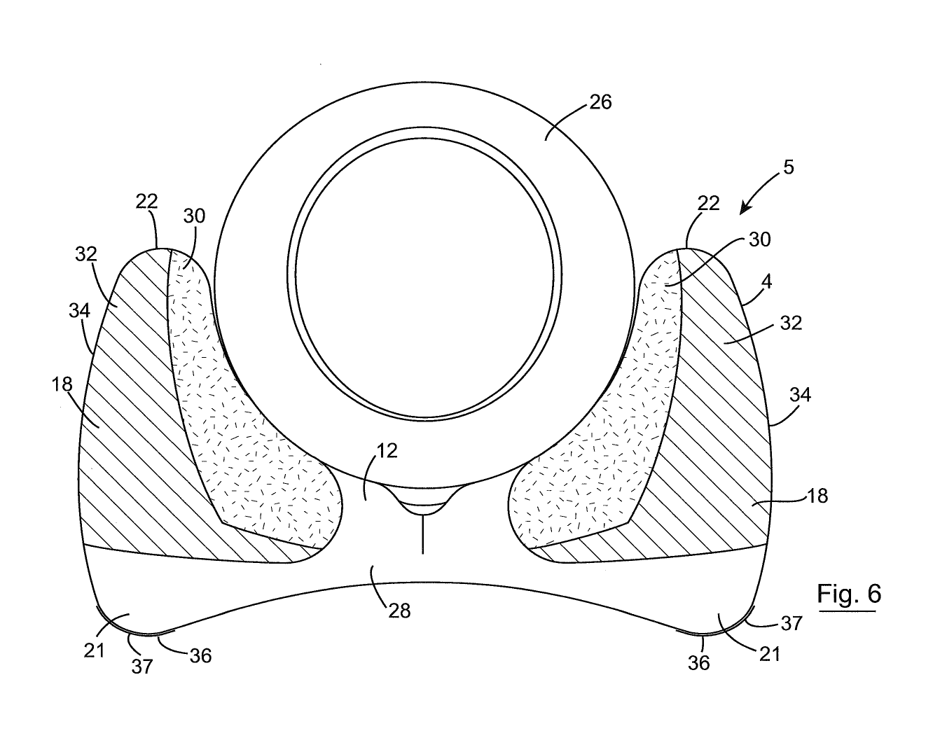

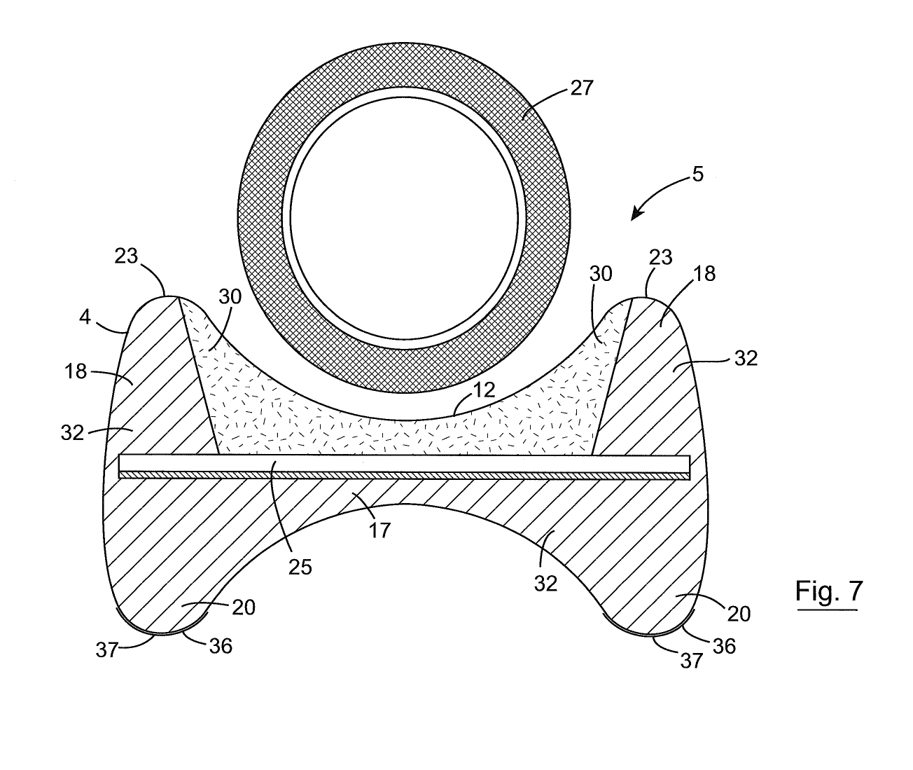

FIG. 7 is a transverse cross-sectional end elevational view of the head support device of FIG. 3,

FIG. 8 is a view similar to that of FIG. 7 illustrating the head support device of FIG. 3 in use,

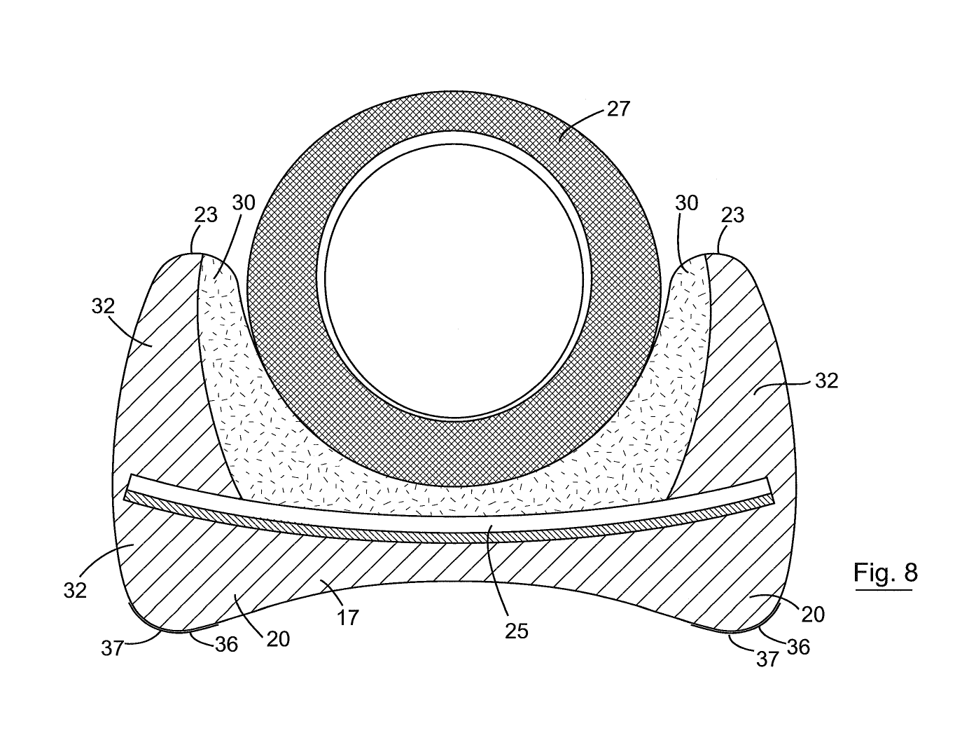

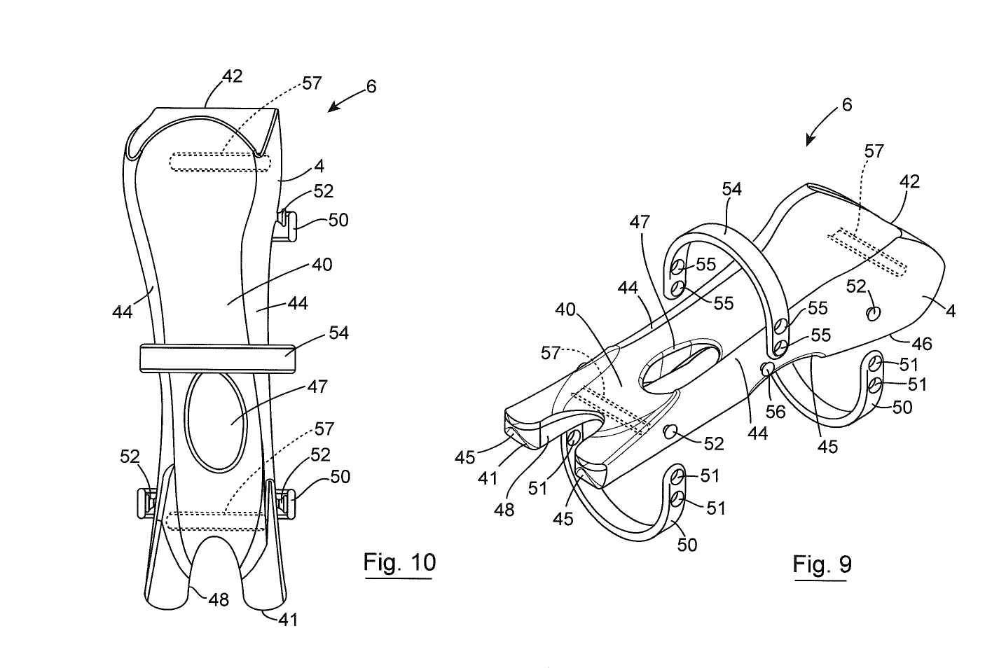

FIG. 9 is a perspective view of an arm support device of the kit of parts of FIG. 1,

FIG. 10 is a top plan view of the arm support device of FIG. 9,

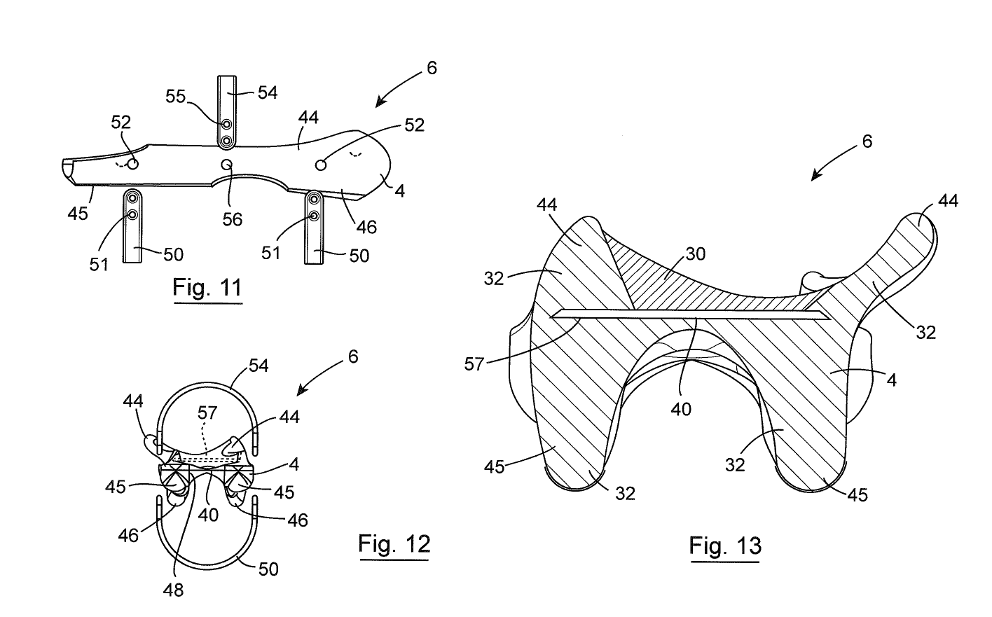

FIG. 11 is a side elevational view of the arm support device of FIG. 9,

FIG. 12 is an end elevational view of the arm support, device of FIG. 9,

FIG. 13 is a transverse cross-sectional end elevational view of the arm support of FIG. 9,

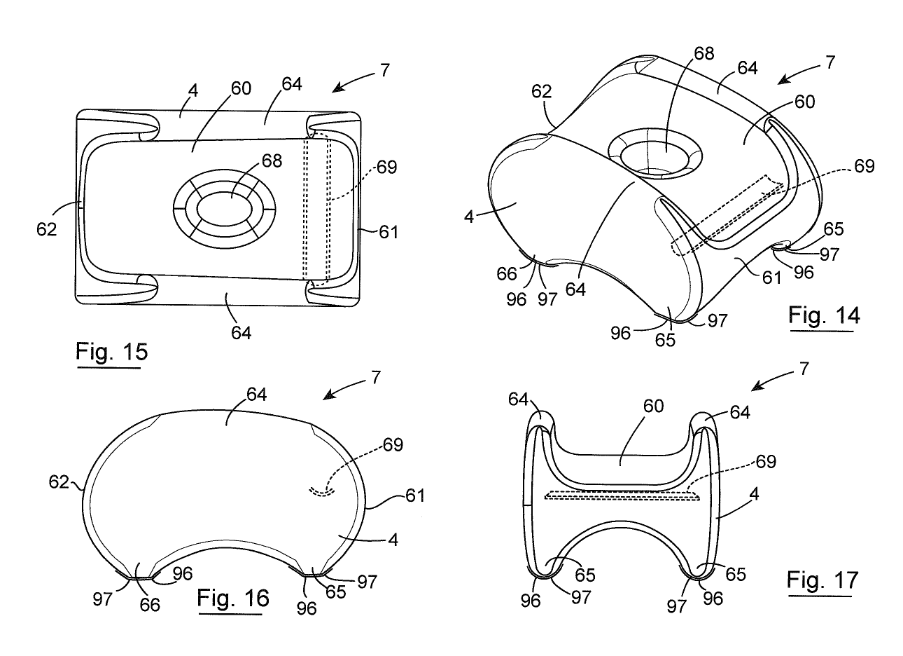

FIG. 14 is a perspective view of a leg support device of the kit of parts of FIG. 1,

FIG. 15 is a top plan view of the leg support device of FIG. 14,

FIG. 16 is a side elevational view of the leg support device of FIG. 14,

FIG. 17 is an end elevational view of the leg support device of FIG. 14,

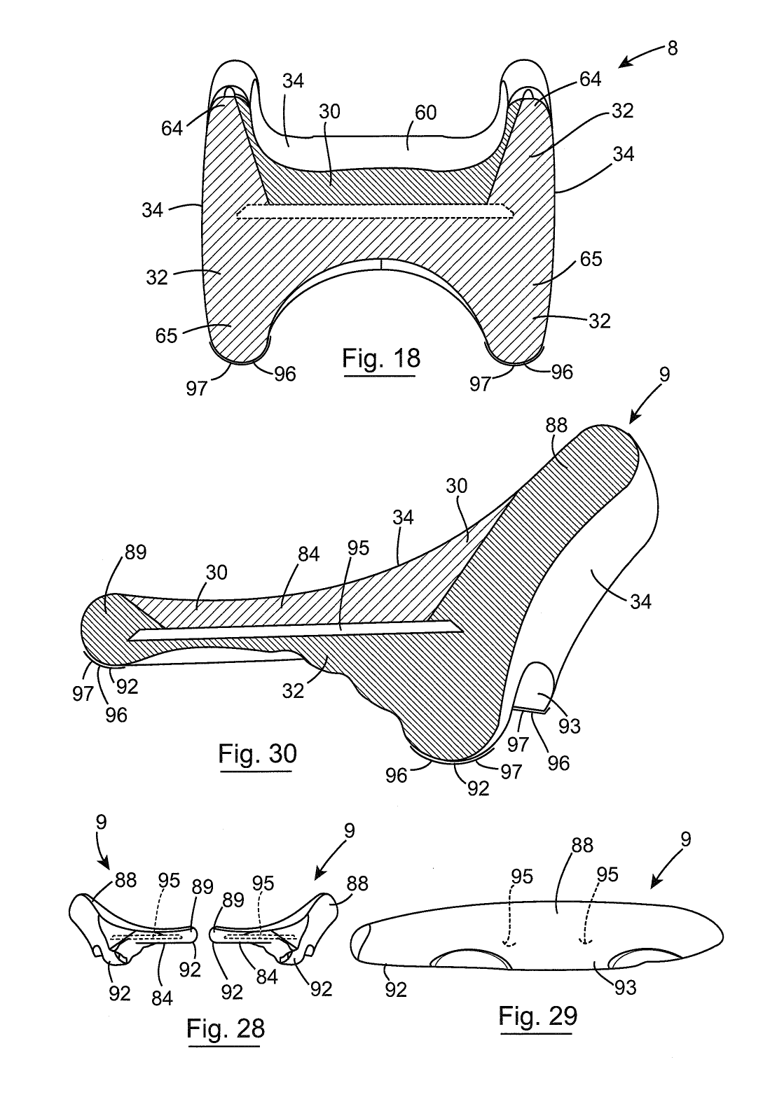

FIG. 18 is a transverse cross-sectional end view of the leg support device of FIG. 14,

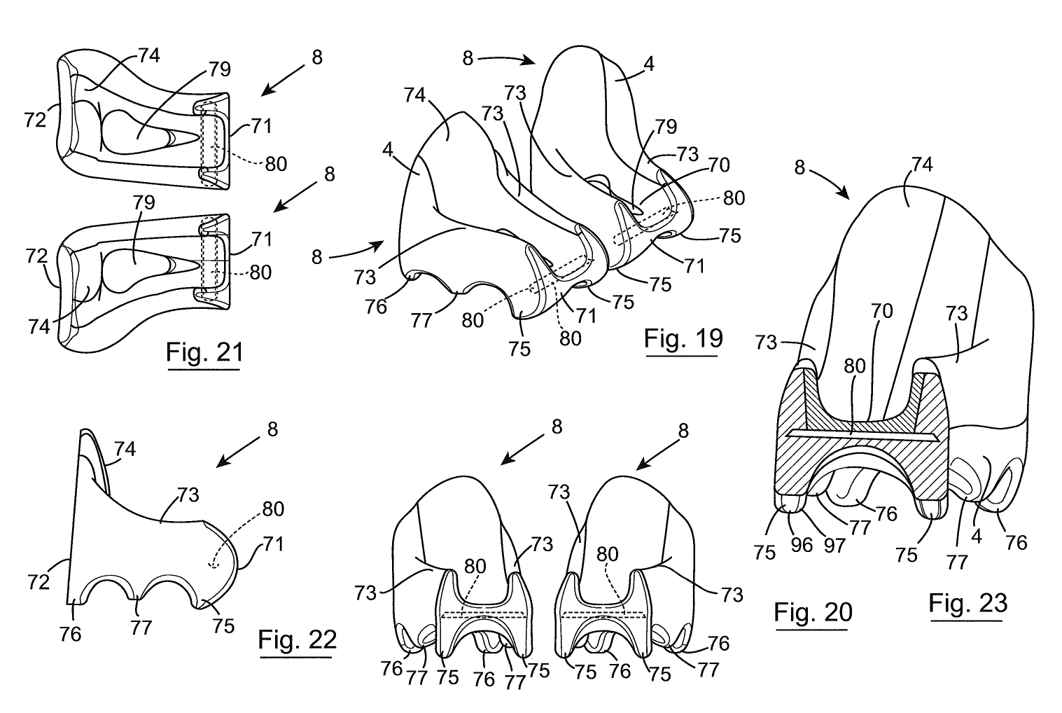

FIG. 19 is a perspective view of a pair of foot support devices of the kit of parts of FIG. 1,

FIG. 20 is another perspective view of the foot support devices of FIG. 19,

FIG. 21 is a top plan view of the foot support devices of FIG. 19,

FIG. 22 is a side elevational view of one of the foot support devices of FIG. 19,

FIG. 23 is a transverse cross-sectional end view of one of the foot support devices of FIG. 14,

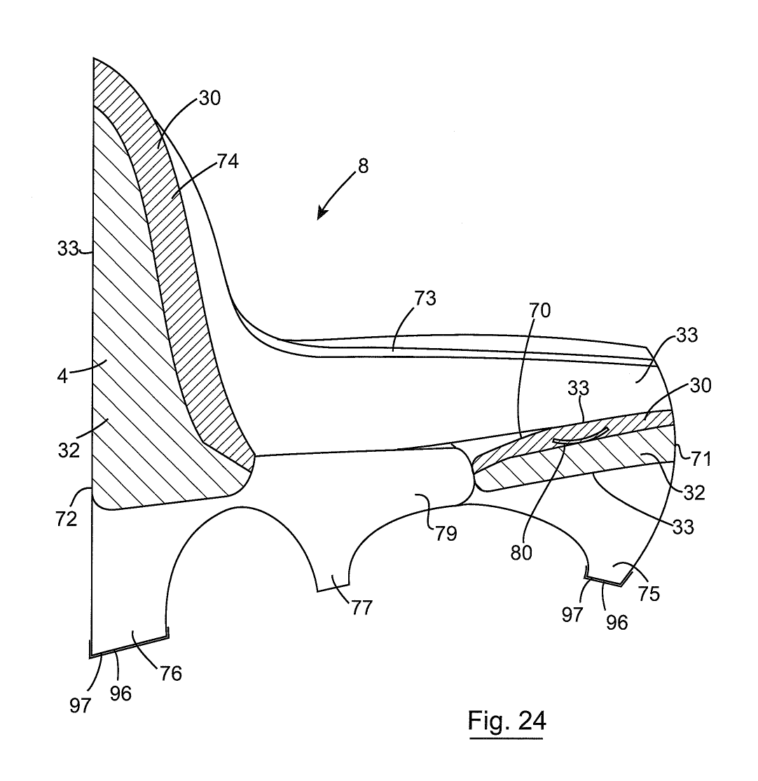

FIG. 24 is a transverse cross-sectional side view of one of the foot support devices of FIG. 19,

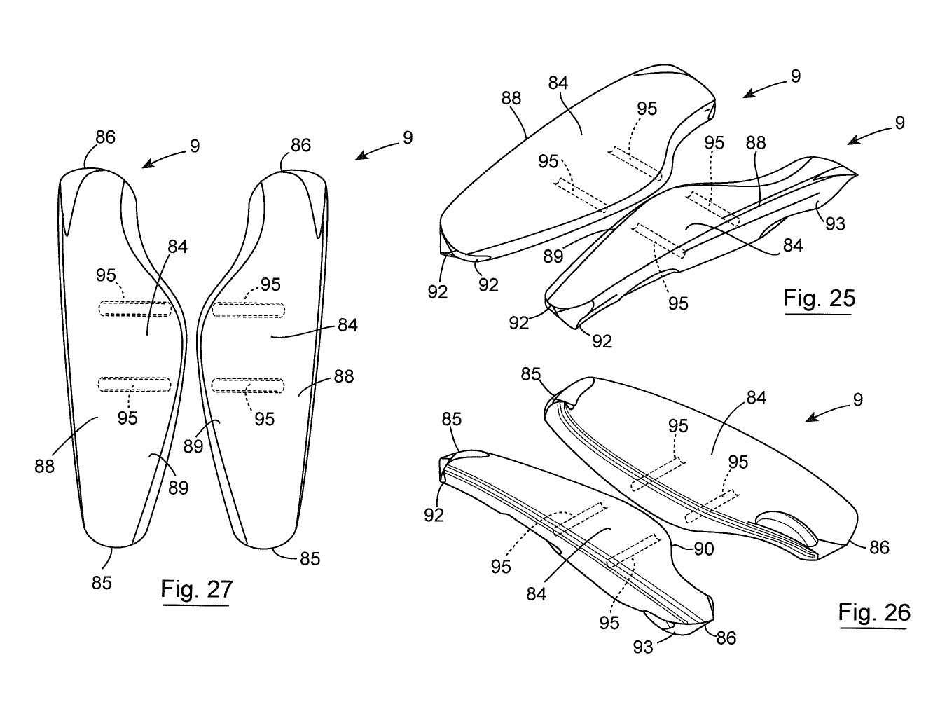

FIG. 25 is a perspective view of a pair of trunk support devices of the kit of parts of FIG. 1,

FIG. 26 is another perspective view of the trunk support devices of FIG. 25,

FIG. 27 is a top plan view of the trunk support devices of FIG. 25,

FIG. 28 is an end elevational view of the trunk support devices of FIG. 25,

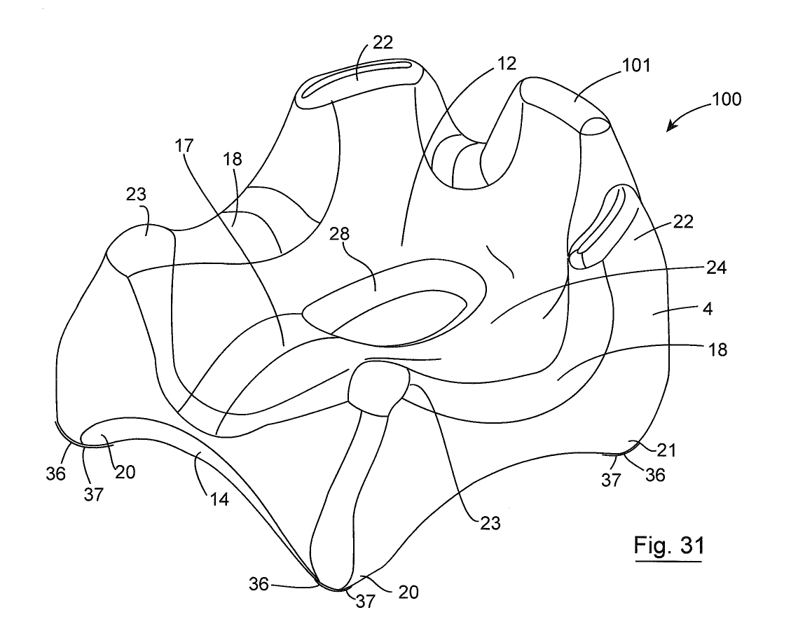

FIG. 29 is a side elevational view of one of the trunk support devices of FIG. 25,

FIG. 30 is a transverse cross-sectional end elevational view of one of the trunk support devices of FIG. 25,

FIG. 31 is a perspective view of a head support device according to another embodiment of the invention, and

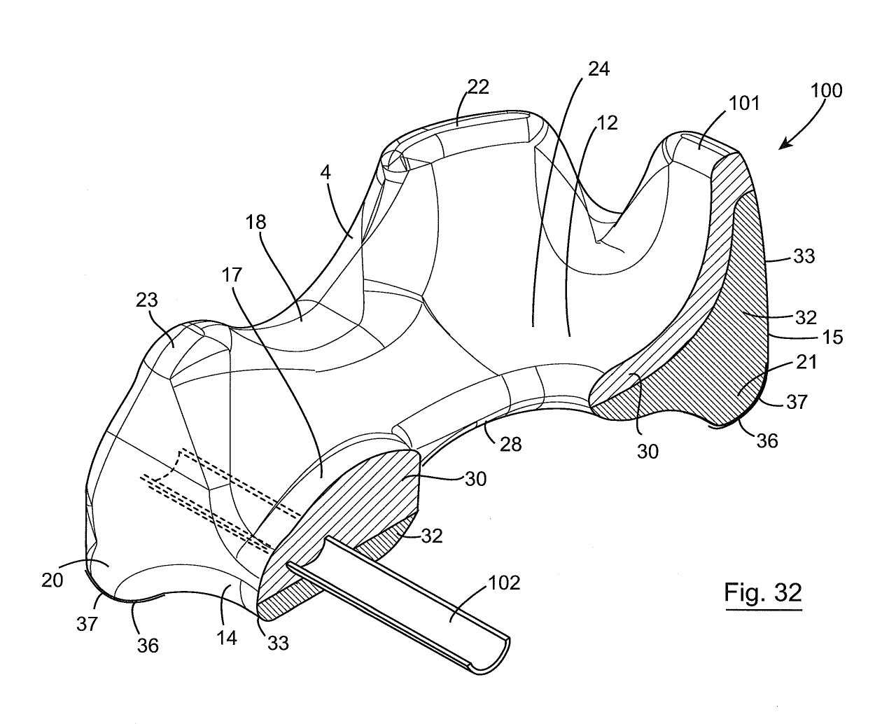

FIG. 32 is a partly cutaway cross-sectional perspective view of the head support device of FIG. 31.

Referring to the drawings and initially to FIGS. 1 to 30, there is illustrated a kit of parts according to the invention, indicated generally by the reference numeral 1, for supporting a subject 2 in a supine state on a support platform, for example, a surgical operating table 3. The kit of parts 1 comprises a plurality of support devices, indicated generally by the reference numeral 4, each of which are also according to the invention, and each of which are provided for supporting different parts of the subject 2 on the operating table 3. The support devices of the kit of parts 1 in this embodiment of the invention comprise a head support device according to the invention, indicated generally by the reference numeral 5, for supporting the head and neck of the subject 2 on the operating table 3, a pair of arm support devices also according to the invention, indicated generally by the reference numeral 6, for supporting and restraining movement of the arms of the subject 2 on the operating table 3, a pair of leg support devices also according to the invention, indicated generally by the reference numeral 7, for supporting the legs of the subject 2 behind the knees on the operating table 3. The support devices of the kit of parts 1 also comprises a pair of foot support devices also according to the invention, indicated generally by the reference numeral 8, for supporting the feet of the subject 2 on the operating table 3, and a pair of trunk support devices also according to the invention, indicated generally by the reference numeral 9, for supporting the trunk of the body of the subject 2 on the operating table 3.

Referring initially to FIGS. 3 to 8, the head support device 5 will first be described. The head support device 5 comprises a central support element 12 of resiliently deformable material for engaging the back of the head of the subject. The central support element 12 extends between a first end 14 and a second end 15 and terminates in its first end 14 in a raised end support element, namely, a raised neck support element 17. Spaced apart raised side support elements 18 of resiliently deformable material extend longitudinally along the central support element 12 on opposite sides thereof for supporting the sides of the head and the sides of the neck of the subject as will be described below. Three platform engaging elements, namely, a pair of first platform engaging elements 20 also of resiliently deformable material extend downwardly from the central support element 12 adjacent the neck engaging element 17 beneath the side support elements 18, and a second platform engaging element 21 extends downwardly from the central support element 12 adjacent the second end 15 thereof. The first and second platform engaging elements 20 and 21 engage the operating table 3 for supporting the central support element 12 above and spaced apart from the operating table 3. In this embodiment of the invention the second platform engaging element 21 is of arcuate shape and extends around the second end 15 of the central support element 12 from one side thereof adjacent the second end 15 to the other side thereof adjacent the second end 15.

The raised side support elements 18 each define a corresponding primary side member 22 which extends upwardly from the central support element 12 adjacent the second end 15 for engaging and supporting the adjacent side of the head of the subject. Each side support element 18 also defines a secondary side member 23 which extends upwardly from the central support element 12 adjacent the first end 14 thereof and adjacent the neck support element 17 for engaging and supporting the adjacent side of the neck of the subject.

The central support element 12 is concave when viewed in plan from above to form a dished area 24 within which the back of the head of the subject is supported. Additionally, the central support element 12 when viewed from beneath in conjunction with the first and second platform engaging elements 20 and 21 is also concave, so that the central support element 12 is spaced apart by the first and second platform engaging elements 20 and 21 above the operating table 3.

The head support device 5 is operable in a loaded state when the head support device 5 is supporting the head and neck of a subject, see FIGS. 6 and 8, where the head and neck are identified by the reference numerals 26 and 27, respectively, and in an unloaded state when the load of the head 26 and neck 27 have been removed from the head support device 5, see FIGS. 5 and 7. In the loaded state with the central support element 12 supporting the head of the subject and the neck support element 17 supporting the neck 27 of the subject, the action of the head 26 and neck 27 of the subject on the central support element 12 and the neck support element 17 urge the central support element 12 and the central portion of the neck support element 17 downwardly, see FIGS. 6 and 8. The central support element 12 co-operates with the neck support element 17 and with the primary and secondary side members 22 and 23, as well as with the first and second platform engaging elements 20 and 21, so that in the loaded state, the downward movement of the central support element 12 and the central portion of the neck support element 17 urge the primary and secondary side members 22 and 23 inwardly into engagement with the adjacent sides of the head 26 and neck 27, respectively, of the subject as can be seen in FIGS. 6 and 8. With the sides of the head and neck of the subject engaged by the primary and secondary side members 22 and 23, respectively, the head and neck of the subject are partly embraced by the head support device 5. Additionally, on the load being removed from the head support device 5, the central support element 12 co-operates with the neck support element 17 and the primary and secondary side members 22 and 23, as well as with the first and second platform engaging elements 20 and 21 to resiliently urge the primary and secondary side members 22 and 23 outwardly in order to return the head support device to the unloaded state, see FIGS. 5 and 7.

An elongated resiliently deformable strengthening member 25 is located in the neck support element 17 and extends transversely of the central support element 12 between the first platform engaging elements 20. The strengthening member 25 fulfils three functions. Firstly, when the head support element 5 is in an unloaded state, the strengthening member 25 acts to retain the head support device 5 in its normal unloaded state. The strengthening member 25 also co-operates with the neck support element 17, the central support element 12 and the secondary side members 23 as well as with the first platform engaging elements 20 to enhance the urging of the secondary side members 23 inwardly into engagement with the respective sides of the neck of the subject when the head support device 5 is in the loaded state supporting a head and neck on the central support element 12 and the neck support element 17, respectively, see FIG. 8. The strengthening member 25 further co-operates with the central support element 12, the neck support element 17 and the primary and secondary side members 22 and 23 as well as with the first platform engaging elements 20 for enhancing the returning of the head support device 5 to its unloaded state, and in particular for returning the head support device 5 to the unloaded state almost instantaneously as the load is removed from the head support device 5, see FIGS. 5 and 7.

As the head support device 5 is being loaded, the downward movement of the central portion of the neck support element 17 deflects the central portion of the strengthening member 25 downwardly relative to the ends thereof, see FIG. 8. The co-operating action of the central support element 12 and the neck support element 17 as well as the strengthening member 25 urges the primary and secondary side members 22 and 23 inwardly into engagement with the sides of the head and the neck, respectively, see FIGS. 6 and 8. On the load being removed from the head support device 5, the resilience and co-operating action of the central support element 12, the neck support element 17 and the strengthening member 25 resiliently returning to their unloaded states urge the primary and secondary side members 22 and 23 outwardly relative to the central support element, thereby returning the head support device 5 to the unloaded state as illustrated in FIGS. 5 and 7.

A central air accommodating opening 28 is located in and extends through the central support element 12 for accommodating a rear bony prominence of the head of the subject therethrough for avoiding pressure on the rear bony prominence of the head. The air accommodating opening 28 also facilitates air circulation around the portion of the head exposed by the opening 28 in order to minimise and, in general, avoid development of pressure sores on the head of the subject.

Turning now in more detail to the construction of the head support device 5, the head support device 5 is of layered construction and comprises a first layer 30 of a first resilient material, and a second layer 32 of a second resilient material. The first layer 30 is supported on the second layer 32. The central support element 12 and the primary and secondary side support members 22 and 23 are formed by the first and second layers 30 and 32. The first and second platform engaging elements 20 and 21 are formed exclusively from the second layer 32. A third layer 34 of a third resilient material is coated onto exposed surfaces of the first layer 30 and the second layer 32 to encapsulate the head support device 5. The third layer 34 is a relatively thin layer of thickness of the order of 1 mm.

The first resilient material of the first layer 30 is a visco elastic foam plastics material of topical density of 70 gms per litre, and a shore hardness of the order of 55 Shore 00. The second resilient material of the second layer 32 is a resilient foam plastics material of topical density value of 140 gms per litre, and of shore hardness of the order of 75 Shore 00. The third resilient material of the third layer 34 is a rubber coating of shore hardness 10 to 20 Shore A, and of high tear strength properties.

The first layer 30 is located on the second layer 32 so that the first layer 30 supports the head and neck of the subject through the adjacent portions of the third layer 34. The first layer 30 being of shore hardness of the order of 55 Shore 00 is a relatively malleable type material so that both the central support element 12 and the primary and secondary side members 22 and 23 essentially adapt to the broader contours of the engaged portions of the skin of the subject, to thereby maximise the area of contact between the skin of the subject to in turn distribute the load resulting from the weight of the subject 2 over the greatest possible area, to in turn reduce the pressure on the skin of the subject. The third layer 34 follows the contours imposed on the first layer 30 by the skin of the subject.

The strengthening member 25 is located between the boundary of the first and second layers 30 and 32 in the neck support element 17, and extends into the second layer 32 between the first platform engaging elements 20 and the secondary side members 23. The strengthening member 25 is of arcuate transverse cross-section formed by a segment of a circle of radius in the order of 10 mm to 30 mm and extending an angular distance of approximately 104°. The strengthening member 25 is of a plastics material, in this case a thermoplastics material of minimum flexural strength of 5.5 Newton load, and is located in the neck support element 17 with the arcuate transverse cross-section being concave when viewed from above.

The provision of the strengthening member 25 of the arcuate transverse cross-section provides the strengthening member 25 with the minimum flexural strength of 5.5 Newton load, and thus the strengthening member 25 is resiliently deformable. The strengthening member 25 as discussed above resiliently co-operates with the central support element 12, the neck support element 17 and the primary and secondary side members 22 and 23, as well as with the first and second platform engaging elements 20 and 21 to return the head support device 5 to its normal unloaded state substantially instantaneously on the load being removed from the head support device 5. Additionally, the strengthening member 25 co-operates with the central support element 12, the neck support element 17 and the secondary side members 23 together with the first platform engaging elements 20 for urging the secondary side members 23 inwardly from the unloaded state into engagement with the side of the neck of the subject when the head support device 5 is loaded with the head and neck of the subject being supported on the central support element 12 and the neck support element 17, respectively. The central support element 12 co-operates with the primary side members 22 and the first and second platform engaging elements 20 and 21 for urging the primary side members 22 inwardly from the unloaded state into engagement with the side of the head of the subject on the head support device 5 being loaded with the head and neck of the subject supported on the central support element 12 and the neck support element 17.

The inward action of the primary and secondary side members 22 and 23 to engage the sides of the head and neck, respectively of the subject when the head support device 5 is in the loaded state with the head and neck of the subject supported on the central support element 11 and the neck support element 17, respectively, restrain movement of the head and neck of the subject.

The co-operating action between the strengthening member 25 and the central and neck support elements 12 and 17 and the secondary side members 23 whereby the secondary side members 23 are urged inwardly and outwardly in response to the head support device 5 being loaded and unloaded is achieved by the resilience of the strengthening member 25 and by virtue of the fact that the strengthening member 25 is embedded in the second layer 32 which is harder and more resilient than the first layer 30. Therefore, as the central portion of the neck engaging element 17 and in turn the central portion of the strengthening member 25 are being deflected downwardly by the weight of the neck of a subject thereon, the ends of the strengthening member 25 are deflected upwardly, and thus, the secondary side members 23 are deflected inwardly to engage the sides of the neck of the subject. However, the resilience of the strengthening member 25 is such that in conjunction with the resilience of the second layer 30, as soon as the load is removed from the head support device 5, the strengthening member 25 in conjunction with the second layer 32 substantially instantaneously urges the secondary side members 23 outwardly into the unloaded state. This outward urging action is transferred through the side support elements 18 from the secondary side members 23 to the primary side members 22 for in turn urging the primary side members outwardly into the normal unloaded state. Additionally, the resilience of the central support element 12 is such that as the central support element 12 is deflected downwardly relative to the first and second platform engaging elements 20 and 21 on the head support device 5 being loaded, the downward deflection of the central support element 12 urges the primary side members 22 inwardly into engagement with the side of the head of the subject, and vice versa when the head support device is unloaded.

The spacing between the first platform engaging elements 20 and between the first platform engaging elements 20 and the second platform engaging element 21 facilitates air circulation to the air accommodating opening 28 beneath the central support element 12 so that the portion of the head exposed by the air accommodating opening 28 is exposed to the circulating air. Additionally, the spacing between the primary and secondary side members 22 and 23 and between the primary side members 22 also accommodates air to circulate around the head of the subject.

The first and second platform engaging elements 20 and 21 terminate in platform engaging surfaces 36 which are provided with a non-slip coating 37 in order to minimise relative movement between the first and second platform engaging elements 20 and 21 and the operating table 3. By minimising relative movement of the first and second platform engaging elements 20 and 21 relative to the operating table 3, the urging effect of the downward movement of the neck engaging element 17 and the central support element 12 on the primary and secondary side members 22 and 23 for urging the primary and secondary side members 22 and 23 into engagement with the sides of the head and neck of the subject, respectively, is enhanced.

Referring now to FIGS. 9 to 13, the arm support devices 6 will now be described. The arm support devices 6 are similar to each other, with the exception that one is a left arm support device and the other is a right arm support device. Accordingly, for convenience only one of the arm support devices 6 will be described. Each arm support device 6 comprises an elongated central support element 40 of resiliently deformable material as will be described below, and which is substantially similar to that of the central support element 12 of the head support device 5. The central support element 40 extends from a first end 41 to a second end 42, the first end 41 being adapted to support the arm adjacent the shoulder, and the second end 42 being adapted to support the hand. Longitudinally extending side support elements 44 extend along respective opposite sides of the central support element 40 for supporting the sides of the arm when the arm is supported on the central support element 40.

A pair of first platform engaging elements 45 and a pair of second platform engaging elements 46 extend downwardly from the central support element 40 on respective opposite sides thereof for supporting the central support element 40 spaced apart above the operating table 3. The first platform engaging elements 45 extend from the first end 41 of the central support element 40 while the second platform engaging elements 46 extend from the second end 42 of the central support element 40. The first and second platform engaging elements 45 and 46 are separated from each other by arcuate recesses 45.

The central support element 40 and the side support element 44 when viewed in plan from above define a concave surface. The central support element 40 and the first and second platform engaging elements 45 and 46 when viewed from underneath also define a concave surface.

An air accommodating opening 47 formed in and extending through the central support element 40 accommodates the elbow bone in order to avoid the elbow bone being subjected to excessive pressure. Air is accommodated into the air accommodating opening 47 through the arcuate recesses 45 to facilitate air circulation around the portion of the elbow exposed by the air accommodating opening 47. An elongated slot 48 extends longitudinally into the central support element 40 adjacent the first end 41 thereof for accommodating air to the upper portion of the arm exposed by the slot 48.

A securing means comprising a pair of securing straps 50 having openings 51 located at respective opposite ends of the securing straps 50 are engageable with corresponding button elements 52 on the sides of the arm support device 6 for securing the arm support device 6 to the operating table 3. A retaining means comprises a retaining strap 54 for securing and restraining an arm of the subject in the arm support device 6. Openings 55 at respective opposite ends of the restraining strap 54 are engageable with button elements 56 on the arm support device 6 for securing the retaining strap 54 to the arm support device 6.

The construction of the arm support device 6 is substantially similar to the construction of the head support device 5 and similar components are identified by the same reference numerals. The central support element 40 and the side support elements 44 are formed by first and second layers 30 and 32 of first and second resilient materials which are similar to the first and second resilient materials of the first and second layers 30 and 32, respectively, of the head support device 5. The first and second platform engaging elements 45 and 46 are formed exclusively of the second resilient material of the second resilient layer 42. The exposed surfaces of the first and second layers 30 and 32 are coated with a third layer 34 of a third resilient material which is similar to the third resilient material of the third layer 34 of the head support device 5.

A pair of elongated resiliently deformable strengthening members 57 of arcuate transverse cross-section, which are similar to the strengthening member 25 of the head support device 5, are located in and extend transversely across the central support element 40 towards the first and second ends 41 and 42. The strengthening members 57 extend between the first and second platform engaging elements 45 and 46, respectively, and fulfil similar functions in connection with the arm support device 6 as are fulfilled by the strengthening member 25 of the head support device 4. The strengthening members are located in the central support element 40 along the boundary of the first and second layers 30 and 32, and extend into the second resilient material of the first and second platform engaging elements 45 and 46.

The strengthening members 57 co-operate with the central support element 40 and the side support elements 44 for maintaining the arm support device 6 in the unloaded state when the arm support device 6 is unloaded. The strengthening members 57 co-operate with the central support element 40 and the side support elements 44 to urge the side support elements 44 inwardly into engagement with the opposite sides of the arm when the arm support device 6 is in the loaded state with the arm supported on the central support element 40. The strengthening members 57 also co-operates with the central support element 40 and the side support elements 44 to return the arm support device 6 outwardly to the unloaded state substantially instantaneously on the arm support device 6 being unloaded.

Referring now to FIGS. 14 to 18, the leg support devices 7 will now be described. The leg support devices 7 are similar to each other, and for convenience only one of the leg support devices 7 will be described. Each leg support device 7 comprises a central support element 60 extending from a first end 61 to a second end 62 for supporting a leg of the subject behind the knee thereof. A pair of raised side support elements 64 extend longitudinally on respective opposite sides of the central support element 60 for supporting respective opposite sides of a leg of the subject adjacent the knee thereof. A pair of spaced apart first platform engaging elements 65 extend downwardly from the central support element 60 adjacent the first end 61, and a pair of second platform engaging elements 66 extend downwardly from the central support element 60 adjacent the second end 62 for supporting the central support element 60 spaced apart above the operating table 3. The central support element 60 and the side support elements 64 when viewed in plan from above define a concave surface. The central support element 60 and the first and second platform engaging elements 65 and 66 when viewed from underneath also define a concave surface.

An air accommodating opening 68 through the central support element 60 exposes a portion of the leg behind the knee to provide air circulation around the exposed portion thereof. The air accommodating opening 68 also relieves pressure on the vital saphenous vein, thereby minimising the risk of deep vein thrombosis developing during a procedure while the legs of the subject are supported on the leg support devices 7.

An elongated resiliently deformable strengthening member 69 of arcuate transverse cross-section which is similar to the strengthening member 25 described with reference to the head support device 5 is embedded in and extends transversely across the central support element 60 adjacent the first end 61 and between the first platform engaging elements 65. The function of the strengthening member 69 is substantially similar to the function of the strengthening member 65 of the head support device 5.

The construction of the leg support device 7 is substantially similar to the layered construction of the head support device 5, and similar components are identified by the same reference numerals. The central support element 60 and the side support elements 64 are formed by a first layer 30 of the first resilient material and a second layer 32 of the second resilient material. The first and second platform engaging elements 65 and 66 are formed of the second resilient material of the second layer 32. The exposed surfaces of the first and second layers 30 and 32 are coated with a third layer 34 of the third resilient material.

The strengthening member 69 is located between the boundaries of the first and second layers 30 and 32 in the central support element 60 and extends into the second resilient material of the first platform engaging element 65. The strengthening member 69 co-operates with the central support element 60 and the side support elements 64 for urging the side support elements inwardly into engagement with the sides of the knee when the leg support device 7 is in the loaded state with a leg of the subject supported on the central support element 60. The strengthening member 69 co-operates with the central support element 60 and the side support elements 64 for maintaining the leg support device 7 in the unloaded state when the leg support device 7 is no longer supporting a leg thereon. The strengthening member 69 co-operates with the central support element 60 and the side support elements 64 for substantially instantaneously urging the side members 64 outwardly for returning the leg support device 7 to the unloaded state on the load being removed from the leg support device 7.

Referring now to FIGS. 19 to 24, the foot support devices 8 will now be described. The foot support devices 8 are similar to each other, and only one of the foot support devices 8 will be described. Each foot support device 8 comprises a central support element 70 extending between a first end 71 and a second end 72 for supporting the heel of a foot of the subject. A pair of spaced apart raised side support elements 73 extend on respective opposite sides of the central support element 70 for engaging the ankles of the leg adjacent the foot supported in the foot support device 8. A foot engaging element 74 extends upwardly from the central support element 70 adjacent the second end 72 thereof and between the side support elements 73 for abutting the sole of the foot of the subject supported in the foot support device 8.

A pair of spaced apart first platform engaging elements 75 extend downwardly from the central support element 70 adjacent the first end 71 thereof beneath the side support element 73, and a spaced apart pair of second platform engaging elements 76 extend downwardly from the central support element 70 adjacent the second end 72 thereof beneath the side support elements 73. The first and second platform engaging elements 75 and 76 support the central support element 70 spaced apart above the operating table 3.

A pair of spaced apart intermediate platform engaging elements 77 extend downwardly from the central support element 70 beneath the side support elements 73 and are of length shorter than the first and second platform engaging elements 75 and 76. The intermediate platform engaging elements 77 only engage the operating table 77 when the foot support device 8 is in the loaded state with a foot supported on the central support element 70, and thereby maintain the central support element 70 spaced apart above the operating table 3 when the foot support device 8 is in the loaded state, in order to facilitate air circulation between the central support element 70 and the operating table 3.

The central support element 70 and the side support elements 73 when viewed in plan from above define a concave surface. The central support element 70 and the first and second platform engaging elements 75 and 76 when viewed in plan from beneath also define a concave surface so that the central support element 70 is supported spaced apart above the operating table 3 by the first and second platform engaging elements 75 and 76.

An air accommodating opening 79 extending through the central support element 7 accommodates the bony prominence to the rear of the heel when the foot of a leg of the subject is supported in the foot support device 8. The air accommodating opening 79 also accommodates air circulation around the portion of the foot exposed by the air accommodating opening 79.

The foot support device 8 is of substantially similar layered construction to that of the head support device 5, and similar components are identified by the same reference numerals. The central support element 70 and the side support elements 73 are formed by first and second layers 30 and 32 of first and second resilient materials, respectively, which are similar to the first and second resilient materials of the first and second layers 30 and 32 of the head support device 5. Additionally, the foot engaging element 74 is of similar layered construction being formed of a first layer 30 and a second layer 32 of the first and second resilient materials respectively, which are similar to the first and second resilient materials of the first and second layers 30 and 32 of the head support device 5, the first layer 30 of the foot support element 74 being supported by the second layer 32 so that the first layer 30 is closer to the foot than the second layer 32. The first, second and intermediate platform engaging elements 75, 76 and 77 are formed of the second resilient material. A third layer 34 of a third resilient material similar to the resilient material of the third layer of the head support device 5 is provided over the exposed surfaces of the first and second layers 30 and 32.

A resiliently deformable strengthening member 80 of arcuate transverse cross-section which is similar to the strengthening member 25 of the head support device 5 extends transversely across the central support element 70 adjacent the first end 71 of the central support element 70 between the first platform engaging elements 75. The strengthening member 80 is embedded in the central support element 70 and is located in the central support element 70 between the boundaries of the first and second layers 30 and 32. Additionally, the strengthening member 80 extends into the second resilient material of the first platform engaging elements 75. The strengthening member 80 co-operates with the central support element 70 and with the side support elements 73, as well as with the first platform engaging elements 75, for urging the side support elements 73 inwardly into engagement with the ankles of the leg of a subject when the foot support device 8 is in the loaded state with the central support element 70 supporting the heel therein. The central support element 70 co-operates with the foot engaging element 74, as well as with the first and second platform engaging elements 75 and 76, for urging the foot engaging element 74 inwardly into engagement with the sole of a foot supported in the foot support device 8 when the foot support device 8 is in the loaded state with a foot supported therein. The strengthening member 80 also co-operates with the central support element 70 and the side support elements 73 and with the foot engaging element 74, as well as with the first and second platform engaging elements 75 and 76, for substantially instantaneously urging the side support elements 73 and the foot support element 74 outwardly and returning the foot support device 8 to its unloaded state when the load is removed from the foot support device 8.

Additionally, the strengthening member 80 co-operates with the central support element 70, and the side support elements 73 and the foot engaging element 74 for maintaining the foot support device 8 in the unloaded state when the foot support device 8 is not loaded.

It is believed that by virtue of the fact that the side support elements 73 and the foot engaging element 74 are joined adjacent the second end 72 of the central support element 70, the urging action of the strengthening member 80 for substantially instantaneously urging the side support elements 73 outwardly also has the effect of urging the foot engaging element 74 outwardly when the load is removed from the foot support device 8.

Referring now to FIGS. 25 to 30, the trunk support devices 9 will now be described. With the exception that one of the trunk support devices is a left-hand trunk support device, and the other trunk support device 9 is a right-hand trunk support device, the trunk support devices 9 are similar to each other, and accordingly, only one of the trunk support devices will be described. Each trunk support device 9 comprises an elongated longitudinally extending central support element 84 for supporting a portion of the back of the trunk of the body of the subject towards a corresponding side thereof. The central support element 84 extends longitudinally from a first end 85 to a second end 86.

A pair of spaced apart raised side support elements, namely, a first raised side support element 88 and a second side support element 89 extend longitudinally along respective opposite sides of the central support element 84. The first side support element 88 extends substantially the length of the central support element 84 from the first end 85 to the second end 86, and is provided for engaging and supporting the adjacent side of the trunk of the body of the subject. The second side support element 89 extends also along the central support element 84 substantially the length of the central support element 84 from the first end 85 to the second end 86. The second side support element 89 is provided for supporting the back of the trunk of the subject towards the spine.

A pair of first platform engaging elements 92 are located spaced apart at respective opposite sides of the central support element 84 adjacent the first end 85. One of the first platform engaging elements 92 which extends downwardly from the central support element 84 beneath the second side support element 89 extends substantially the length of the central support element 84. However, the first platform engaging element 92 which extends downwardly from the central support element 84 beneath the first side support element 88 is located adjacent the first end 85 of the central support element 84. A second platform engaging element 93 is located adjacent the second end 86 of the central support element 84 and extends downwardly therefrom beneath the first side support element 88. The first and second platform engaging elements 92 and 93 extend downwardly from the central support element 84 for supporting the central support element 84 spaced apart above the operating table 3 when the trunk support device 9 is in the unloaded state.

The central support element 84 and the first and second side support elements 88 and 89 when viewed in plan from above define a concave surface. The central support element 84 and the first and second platform engaging elements 92 and 93 when viewed from beneath define a concave surface so that the central support element 84 is supported by the first and second platform engaging elements 92 and 93 above the operating table 3.

The trunk support device 9 is operable in two states, namely, a loaded state when the trunk support device 9 is supporting the trunk of the body of a subject and an unloaded state when the load of the trunk has been removed from the trunk support device 9. In the loaded state the central support element 84 and the second side support element 89 support the back of the subject between the spine and the corresponding side of the trunk, and the first side support element 89 is urged inwardly into engagement with the side of the trunk of the subject for supporting the side of the trunk of the subject. In the unloaded state the first and second side support elements 88 and 89 are urged outwardly relative to the central support element 84.

The trunk support device 9 is of layered construction similar to the layered construction of the head support device 5 and similar components of the layered structure are identified by the same reference numerals. The central support element 84 and the first and second side support elements 88 and 89 are formed by first and second layers 30 and 32 of first and second resilient materials which are similar to the first and second resilient materials of the first and second layers 30 and 32 of the head support device 5. The first and second platform engaging elements 32 and 33 are formed of the second resilient material of the second layer 32. The exposed surfaces of the first and second layers 30 and 32 are coated with a third layer 34 of a third resilient material, which is similar to the third resilient material of the third layer 34 of the head support device 5.

A pair of spaced apart resiliently deformable strengthening members 95 extend transversely of and are embedded in the central support element 8 between one of the first platform engaging elements 92 and the other of the first platform engaging element 92 and the second platform engaging element 93. The strengthening members 95 are of arcuate transverse cross-section and are similar to the strengthening member 25 of the head support device 5. The strengthening members 95 are located in the central support element 84 so that when viewed in plan, the strengthening members 95 are concave across their cross-section. Both of the strengthening members 95 extend from the first platform engaging element 92 which extends downwardly from the central support element 84 beneath the second side support element 89. The strengthening member 95 which is closest to the first end 85 of the central support element 84 extends into the first platform engaging element 92 on the side of the central support element 84 from which the first side support element 88 extends. The strengthening member 95 which is closest to the second end 86 of the central support element 84 extends into the second platform engaging element 93 on the side of the central support element 84 which is adjacent the first side support element 88.

The strengthening members 95 are located in the central support element 84 between the boundaries of the first and second layers 30 and 32 and extend into the second resilient material of the first and second platform engaging elements 92 and 93.

The strengthening members 95 co-operate with the central support element 84 and the first and second side support elements 88 and 89 and also with the first and second platform engaging elements 92 and 93 to urge the first side support element 88 inwardly into engagement with the side of the trunk of the body of the subject when the trunk support device 9 is in the loaded state with the central support element 84 and the second side support element 89 supporting the back of the trunk of the subject. The strengthening members 95 co-operate with the central support element 84 and the first and second side support elements 88 and 89 as well as with the first and second platform engaging elements 92 and 93 to return the trunk support device 9 to its unloaded state substantially instantaneously with the load being removed from the trunk support device 9. The trunk support device 9 is returned to the unloaded state by urging the first and second side support elements 88 and 89 outwardly relative to the central support element 84. Additionally, the strengthening members 95 co-operate with the central support element 84 and the first and second side support elements 88 and 89 as well as with the first and second platform engaging elements 92 and 93 to maintain the trunk support device 9 in its unloaded state when the trunk support device 9 is no longer loaded.

The first and second platform engaging elements of the arm support devices 6 and the first and second platform engaging elements 55 and 56 of the leg support devices 7, as well as the first and second platform engaging elements 75 and 76 of the foot support devices 8 and the first and second platform engaging elements 92 and 93 of the trunk support devices 9 each terminate in a platform engaging surface 96 which are coated with a non-slip coating 97 which is similar to the non-slip coating 37 applied to the platform engaging surfaces 36 of the head support device 5 for minimising relative movement of the arm, leg, foot and trunk support devices 6 to 9 on the operating table 3.

In use, the subject is initially placed on the operating table 3, and the support devices 4 are then inserted beneath the subject by manoeuvring the subject appropriately. The head support device 5 is placed on the operating table 3 and is urged into position beneath the head and neck of the subject 2, so that the head of the subject is supported on the central support element 12 and the neck of the subject is supported on the neck support element 17. As the central support element 12 and the neck engaging element 17 commence to take the weight of the head and neck of the subject, the co-operating action between the central support element 12 and the neck engaging element and the strengthening member 25 and the first and second platform engaging elements 20 and 21 with the primary and secondary side members 22 and 23 urge the primary and secondary side members 22 and 23 into engagement with the sides of the head and neck, respectively, of the subject.

The trunk support devices 9 are then placed on the operating table 3 and the subject is manoeuvred to sequentially position the trunk support devices 9 beneath the back of the trunk of the subject on respective opposite sides thereof with the back of the trunk supported on the central support elements 84 and the second side support elements 89 of the trunk support devices 9. As the weight of the subject is being taken by the central support elements 84 and the strengthening members 95 of the trunk support devices 9, the resilient co-operation between the central support element 84 and the strengthening members 95 and the first and second platform engaging elements 92 and 93 with the first and second side elements 88 and 89 of each trunk support device 9 urge the first side elements 88 into engagement with the adjacent sides of the trunk of the subject for supporting thereof.

The leg and foot support devices 7 and 8 are then manoeuvred into position beneath the knee and the heel, respectively, of the subject. As the central support element 60 and the strengthening member 69 of the leg support devices 7 take the weight of the corresponding legs, the co-operating action between the central support element 60 and the strengthening member 69 and the first and second platform engaging elements 65 and 66 with the side support elements 64 urge the side support elements 64 into engagement with the sides of the respective knees of the subject.

As the central support element 70 and the strengthening member 80 of the foot support devices 8 commence to take the weight of the heel and the lower portion of the leg of the subject, the co-operating action between the central support element 70 and the strengthening member 80 and the first and second platform engaging elements 75 and 76 with the side support elements 73 of each foot support device 8 urge the side support elements 73 inwardly into engagement with the opposite sides of the knee of the subject. Additionally, as the central support element 70 of each foot support device 8 commences to take the weight of the heel of the subject, the co-operating action between the central support element 70 and the first and second platform engaging elements 75 and 76 with the foot engaging element 74 urges the foot engaging element 74 into engagement with the sole of the corresponding foot of the subject for supporting thereof.

The arm support devices 6 are then placed on the operating table 3 and the arms of the subject are placed thereon. When the arms of the subject have been manoeuvred into a desired position, the arm support devices 6 are secured to the operating table by the securing straps 50. The retaining straps 54 are then secured for retaining the arms of the subject in the respective arm support devices 6. The action of the arms on the central support element 40 of the arm support devices 6 urges the central support element 40 downwardly towards the operating table 3, and the resilient co-operating action of the central support element 40 and the strengthening members 57 and the first and second platform engaging elements 45 and 46 with the side support elements 44 urge the side support elements 44 inwardly into engagement with the respective opposite sides of the arms of the subject.

Thereafter, the subject is ready for the anaesthetist and the surgeon.

On completion of the operation or other procedure on the subject, the subject is removed from the operating table 3. As the weight of the subject is removed from the respective head, arm, leg, foot and trunk support devices 5 to 9 the action of the strengthening members 25, 57, 69, 80 and 95 substantially instantaneously return the respective support devices 4 to their unloaded state.

Referring now to FIGS. 31 and 32, there is illustrated a head support device according to another embodiment of the invention, indicated generally by the reference numeral 100, for supporting the head and neck of a subject on a support platform, for example, the operating table 3 described with reference to the kit of parts of FIGS. 1 to 30. The head support device 100 is substantially similar to the head support device 5 described with reference to FIGS. 3 to 8, and similar components are identified by the same reference numerals. The head support device 100 may be used in conjunction with the arm support devices 6, the leg support devices 7, the foot support devices 8 and the trunk support devices 9 of the kit of parts described with reference to FIGS. 1 to 30, and in which case, the kit of parts incorporating the head support device 100 would also be a kit of parts according to the invention.

The main difference between the head support device 100 and the head support device 5 is that in the head support device 100 an additional support member is provided, namely, a crown support member 101 which extends upwardly from the central support element 12 adjacent the second end 15 thereof for abutting and supporting the crown of the head of a subject supported in the head support device 100. The crown support member 101 is of layered construction similar to the primary support members 22, and comprises a first layer 30 of the first resilient material, and a second layer 32 of the second resilient material. The first and second resilient materials are similar to the first and second resilient materials of the head support device 5. The first layer 30 of the first resilient material is supported on the second layer 32 of the second resilient material. As can be seen, the first resilient material of the first layer 30 in the crown support member 101 extends from the resilient material of the first layer 30 of the central support element 12, and the second resilient material of the second layer 32 of the crown support member 101 extends from the second resilient material of the second layer 32 of the central support element 12.

The central support element 12 and the first and second platform engaging elements 20 and 21 co-operate with the crown support member 101 so that when the head support device 5 is in the loaded state with the head and neck supported on the central support element 12 and the neck support element 17, respectively, the downward movement of the central support element 12 urges the crown support member 101 inwardly into abutting engagement with the crown of the head of the subject supported in the head support device 100.

The head support device 101 is also provided with a strengthening member 102 which is similar to the strengthening member 25 of the head support device 5 and its location in the neck support element 17 is similar to that of the strengthening member 25 of the head support device 5. In this embodiment of the invention the strengthening member 102 as well as fulfilling all the functions of the strengthening member 25 of the head support device 5 also co-operates with the central support element 12 and the first and second platform engaging elements 20 and 21 and with the crown support member 102 for urging the crown support member 102 outwardly substantially instantaneously as the load is removed from the head support device 100 for returning the head support device 100 to the unloaded state.

Otherwise, the head support device 100 is similar to the head support device 5 and its use is likewise similar.

Although not illustrated, disposable covers are provided for covering each of the support devices 5 to 9 and 100, so that by merely removing and replacing the disposable covers, the support devices 5 to 9 and 100 can be immediately reused, without any need for disinfecting, sterilising or otherwise cleaning the support devices. The disposable covers are tailored to snugly fit each of the support devices, and are made from a non-woven soft fabric, which is soft to the skin of the subject and provides a clean infection control protective barrier between the skin of the subject and the support devices, thereby reducing any risk of cross-infection between patients.

While the kit of parts has been described for supporting a subject on a surgical operating table, the kit of parts may be used for supporting a subject on any other support platform, for example, on a stretcher, on a support platform in an ambulance, or on any other such support platform.

Additionally, while the kit of parts has been described as comprising a plurality of devices, in certain cases, it is envisaged that the kit of parts may be provided with only some of the support devices.

It is also envisaged that each of the devices of the kit of parts may be provided separately in accordance with the invention.

While the support devices according to the invention have been described as comprising a strengthening member, it is envisaged that in some embodiments of the invention some or all of the support devices of the kit of parts, and indeed, the support devices if provided individually may be provided without the strengthening member.

1-206. (canceled)

207. A support device for supporting a part of the body of a subject on a support platform, the support device comprising a central support element for supporting the part of the body, the central support element located between opposite raised side support elements, at least one pair of first platform engaging elements extending downwardly on opposite sides of the central support element for supporting the central support element spaced apart above the platform when the support device is in an unloaded state, and an elongated resiliently deformable strengthening member located in and extending transversely of the central support element between the first platform engaging elements, the strengthening member co-operating with the central support element and the side support elements for urging the side support elements into engagement with respective adjacent portions of the part of the body supported on the central support element when the support device is in a loaded state with the central support element deflected downwardly between the first platform engaging elements by the weight of the part of the body supported thereon and for returning the support device to the unloaded state when the load is removed therefrom.

208. A support device as claimed in claim 207 in which the side support elements are adapted to engage and support the respective adjacent portions of the part of the body supported by the central support element, and preferably, the side support elements are adapted to engage the adjacent portions of the part of the body supported on the central support element so that the part of the body is substantially embraced by the central and side support elements, and advantageously, the first platform engaging elements and the central support element define a concave surface when viewed from underneath, and preferably, the first platform engaging elements extend downwardly from the central support element beneath the side support elements, and advantageously, the central support element is dished when viewed in plan from above, and preferably, the side support elements and the central support element define a concave surface when viewed from above, and advantageously, the central support element extends longitudinally between a first end and a spaced apart second end, the first platform engaging elements being located adjacent the first end of the central support element, and preferably, the strengthening member is located adjacent the first end of the central support element, and advantageously, at least one second platform engaging element extends downwardly from the central support element adjacent the second end thereof.

209. A support device as claimed in claim 208 in which a pair of the second platform engaging elements extend downwardly at opposite sides of the central support element adjacent the second end thereof, and preferably, a pair of the strengthening members are provided, a second one of the strengthening members being located adjacent the second end of the central support element and extending transversely thereof between the second platform engaging elements, and advantageously, each strengthening member co-operates with the corresponding pair of platform engaging elements for urging the side support elements into engagement with the respective opposite sides of the part of the body supported on the central support element when the support device is in the loaded state, and preferably, the resilience of each strengthening member is such as to substantially instantaneously return the support device to its unloaded state once a load has been removed therefrom.

210. A support device as claimed in claim 207 in which each strengthening member is of arcuate transverse cross-section, and preferably, the transverse cross-section of each strengthening member defines a segment of a circle, and advantageously, the segment of the circle defined by the transverse cross-section of each strengthening member extends an angular distance in the range of 90° to 130°, and preferably, the segment of the circle defined by the transverse cross-section of each strengthening member extends an angular distance in the range of 100° to 110°, and advantageously, the segment of the circle defined by the transverse cross-section of each strengthening member extends an angular distance of approximately 104°.

211. A support device as claimed in claim 210 in which each strengthening member is located in the central support element with the transverse cross-section thereof concave when viewed in plan from above, and preferably, each strengthening member is of a plastics material, and advantageously, the flexural strength of each strengthening member lies in the range of 3 Newton load to 15 Newton load, and preferably, the flexural strength of each strengthening member lies in the range of 5 Newton load to 10 Newton load, and advantageously, the flexural strength of each strengthening member lies substantially in the order of 5.5 Newton load.

212. A support device as claimed in claim 207 in which each strengthening member is embedded in the central support element.

213. A support device as claimed in claim 207 in which an air accommodating opening is provided extending through the central support element to accommodate air to a portion of the part of the body of the subject supported thereon, and preferably, the air accommodating opening is adapted to accommodate a bony prominence extending from the part of the body supported on the central support element, and advantageously, the central and side support elements and the platform engaging elements are of a resilient material.

214. A support device as claimed in claim 207 in which the central support element is of layered construction comprising a first layer of a first resilient material, and a second layer of a second resilient material, the second layer supporting the first layer, and being of Shore hardness greater than the Shore hardness of the first layer, and advantageously, each strengthening member is located adjacent a boundary between the first layer and the second layer, and preferably, the side support elements are of layered construction, with the first and second resilient materials of the respective first and second layers of the central support element extending into and forming the side support elements, and advantageously, each platform engaging element comprises the second resilient material, a portion of which extends from the second layer of the central support element to form the corresponding platform engaging element, and preferably, respective opposite ends of the strengthening member extend into the second resilient material of the adjacent platform engaging elements and are embedded therein, and advantageously, the first resilient material is malleable, and preferably, the first resilient material of the first layer is adapted to follow the contours of the part of the body of the subject adjacent thereto, and preferably, the Shore hardness of the first resilient material lies in the range of 20 Shore 00 to 70 Shore 00, and advantageously, the Shore hardness of the first resilient material lies in the range of 50 Shore 00 to 60 Shore 00, and preferably, the Shore hardness of the first resilient material is approximately 55 Shore 00, and advantageously, the Shore hardness of the second resilient material lies in the range of 70 Shore 00 to 99 Shore 00, and preferably, the Shore hardness of the second resilient material lies in the range of 70 Shore 00 to 80 Shore 00, and advantageously, the Shore hardness of the second resilient material is approximately 75 Shore 00, and preferably, a third layer of a third resilient material is coated over exposed surfaces of the first layer, and advantageously, the third resilient material is coated over exposed surfaces of the second layer, and preferably, the Shore hardness of the third resilient material is less than the Shore hardness of the first resilient material, and advantageously, the Shore hardness of the third resilient material lies in the range of 10 Shore A to 50 Shore A, and preferably, the Shore hardness of the third resilient material lies in the range of 10 Shore A to 20 Shore A, and advantageously, the Shore hardness of the third resilient material is approximately 10 Shore A.

215. A support device as claimed in claim 207 in which the central support element is adapted to support the back of the head of a subject lying in a supine state, the central support element terminating adjacent the first end in a raised end support element for supporting the back of the neck of a subject, respective portions of the side support elements adjacent the second end of the central support element forming primary side members for engaging opposite sides of the head of the subject, the strengthening member being located in the central support element adjacent the end support element and co-operating with the side support elements adjacent the first end of the central support element for urging the side support elements adjacent the end support element into engagement with respective opposite sides of the neck of the subject when the support device is in the loaded state supporting the head and neck of the subject, and preferably, the strengthening member co-operates with the primary side members for urging the primary side members into engagement with respective opposite sides of the head of the subject when the support device is in the loaded state, and advantageously, a crown support member extends upwardly from the central support element adjacent the second end thereof for abutting and engaging the crown of the head of a subject, and preferably, the central support element co-operates with the crown support member for urging the crown support member into abutting engagement with the crown of the subject when the support device is in the loaded state.

216. A support device as claimed in claim 207 in which the central support element is adapted for supporting an arm of the subject, and a pair of the strengthening members are located in the central support element towards respective first and second ends thereof, and preferably, a retaining means is provided for retaining an arm of the subject therein, and advantageously, the retaining means comprises a retaining strap releasably coupleable with the support device, and preferably, at least one securing means is provided for securing the support device to the support platform, and advantageously, the at least one securing means is releasably coupleable to the support device, and preferably, the securing means comprises a securing strap coupleable to the support device.

217. A support device as claimed in claim 207 in which the central support element is adapted for supporting a foot of the subject adjacent the heel thereof, the first end of the central support element being adapted to engage a leg of the subject adjacent the ankles thereof, and preferably, the side support elements are adapted for engaging the ankles of the leg of the subject when the support device is in the loaded state supporting the foot of the subject, and advantageously, a foot engaging member extends upwardly from the second end of the central platform for engaging the sole of the foot of the subject, the foot engaging member co-operating with the central support element and the first and second platform engaging elements for urging the foot engaging member into engagement with the foot of the subject when the support device is in the loaded state with the foot of the subject supported therein.

218. A support device as claimed in claim 207 in which the central support element is adapted for supporting one of a leg of a subject at a location behind the knee thereof, and a portion of the trunk of the body of a subject, the central support element and one of the side support elements being adapted for supporting a portion of the trunk of the subject between the spine of the subject and a side of the subject, and the other side support element being adapted for engaging the adjacent side of the trunk of the subject.

219. A support device for supporting a part of the body of a subject, the support device comprising a central support element extending between a first end and a second end, and extending between a pair of raised side support elements located on opposite sides of the central support element, the central support element terminating adjacent the first end thereof in an end support element, a pair of spaced apart first platform engaging elements extending downwardly from the end support element, and at least one second platform engaging element extending downwardly from the central support element adjacent the second end thereof, the central support element and the end support element being of resilient material and co-operating with the side support elements for urging the side support elements into engagement with respective adjacent portions of the part of the body supported by the central support element when the support device is in a loaded state with the part of the body of the subject supported on the central support element and the end support element, and for returning the support device to the unloaded state when the load is removed therefrom.

220. A support device as claimed in claim 219 in which at least one primary support member extends upwardly from the central support element adjacent the second end thereof, and the central support element is co-operable with the at least one primary side member for urging the primary side member into engagement with an adjacent portion of the part of the body when the support device is in a loaded state with the part of the body supported on the central and end support elements, and preferably, a pair of the primary side members are provided on respective opposite sides of the central support element adjacent the second end thereof, and advantageously, a pair of second platform engaging elements extend downwardly from the central support element adjacent the second end thereof, and preferably,
the central support element co-operates with the platform engaging elements for urging each primary side member into engagement with the adjacent portion of the part of the body when the support device is in the loaded state, and advantageously, the end support element co-operates with the platform engaging elements for urging the side support elements into engagement with the adjacent portions of the part of the body, and preferably, the opposite side support elements are located adjacent the end support element, and advantageously, an elongated resiliently deformable strengthening member is located in the end support element and extends transversely of the central support element between the first platform engaging elements, the strengthening member co-operating with the end support element for urging the side support elements into the adjacent portions of the part of the body when the support device is in the loaded state, and for returning the support device to the unloaded state when the load is removed, and preferably, the strengthening member is of arcuate transverse cross-section, and advantageously, the transverse cross-section of the strengthening member defines a segment of a circle, and preferably, an air accommodating opening is provided extending through the central support element to accommodate air to a portion of the part of the body of the subject supported on the central support element, and preferably, the air accommodating opening is adapted to accommodate a bony prominence extending from the portion of the part of the body supported by the central support element, and advantageously, the central and end support elements are of layered construction comprising a first layer of a first resilient material, and a second layer of a second resilient material, the second layer supporting the first layer, and being of Shore hardness greater than the Shore hardness of the first layer, and preferably, the strengthening member is located adjacent a boundary between the first layer and the second layer, and advantageously, the side support elements and each primary support element are of layered construction, with the first and second layers of the central support element extending into and forming the side support elements, and preferably, the platform engaging elements comprise the second resilient material, respective portions of which extend from the second layer of the central support element and the end support element to form the corresponding platform engaging elements, and advantageously, the first resilient material of the first layer is malleable, and preferably, the first resilient material of the first layer is adapted to follow the contours of the part of the body of the subject adjacent thereto, and advantageously, a third layer of a third resilient material is coated over exposed surfaces of the first layer, and preferably, the third layer of resilient material is coated over the exposed surfaces of the second layer, and advantageously, the platform engaging elements and the central support element define a concave surface when viewed from underneath, and preferably, the platform engaging elements extend downwardly from the central support element beneath the side support elements, and advantageously, the central support element is dished when viewed in plan from above, and preferably, the side support elements and the central support element define a concave surface when viewed from above.

221. A head support device for supporting the head of a subject in a supine state, the head support device comprising a central support element for supporting the back of the head of the subject, the central support element extending between a first end and a spaced apart second end, and terminating adjacent the first end in an end support element for supporting the neck of the subject, a pair of spaced apart side support elements located on respective opposite sides of the central support element adjacent the end support element, a pair of spaced apart primary side members extending upwardly from the central support element adjacent opposite sides thereof adjacent the second end of the central support element for engaging opposite sides of the head of the subject, a pair of first platform engaging elements located on opposite sides of the central support element adjacent the end support element and extending downwardly therefrom and at least one second platform support element extending downwardly from the central support element adjacent the second end thereof, the first and second platform engaging elements co-operating for supporting the central support element and the end support element spaced apart above the support platform, the central support element being of a resiliently deformable material and co-operating with the platform engaging elements and the primary side members so that downward movement of the central support element in response to the support device being in a loaded state with the head supported on the central support element urges the primary side members into engagement with the respective sides of the head, and on unloading of the support device the support device is returned to its unloaded state.

222. A support device as claimed in claim 221 in which a crown support member extends upwardly from the central support element adjacent the second end thereof for abutting and engaging the crown of the head of a subject, and preferably, the central support element co-operates with the crown support member for urging the crown support member into abutting engagement with the crown of the subject when the support device is in the loaded state, and advantageously, the end support element is of a resiliently deformable material and co-operates with the side support elements and the first platform engaging elements for urging the side support elements into engagement with opposite sides of the neck of the subject in response to downward movement of the end support element when the support device is in the loaded state with the neck supported on the end engaging element, and for returning the support device to its unloaded state on removal of the load therefrom, and preferably, a pair of the second platform engaging elements extend from the central support element adjacent the second end thereof spaced apart from each other, and advantageously, each second platform engaging element extends from the central support element adjacent the corresponding primary side member, and preferably, the side support elements and the platform engaging elements are of resiliently deformable material, and advantageously, the central support element and the end support element are of layered construction comprising a first layer of a first resilient material, and a second layer of a second resilient material, the second layer supporting the first layer, and being of Shore hardness greater than the Shore hardness of the first layer, and preferably, the side support elements and the primary side members are of layered construction, with the first and second resilient materials of the respective first and second layers of the central support element extending into and forming the primary side members, and the first and second resilient materials of the respective first and second layers extending from the end support element into and forming the side support elements, and advantageously, the platform engaging elements comprise the second resilient material, respective portions of which extend from the second layer of the central support element and the end support element to form the corresponding platform engaging elements, and preferably, the first resilient material is malleable, and advantageously, the first resilient material of the first layer is adapted to follow the contours of the part of the body of the subject adjacent thereto, and preferably, a third layer of a third resilient material is coated over exposed surfaces of the first layer, and advantageously, the third layer of resilient material is coated over exposed surfaces of the second layer, and preferably, an elongated resiliently deformable strengthening member located in the end support element extending in a general direction between the first platform engaging elements for returning the support device to the unloaded state when the load of the head is removed therefrom, and preferably, the strengthening member is embedded in the end support element, and advantageously, the strengthening member extends from one of the first platform engaging elements and the other of the platform engaging elements, and preferably, the strengthening member co-operates with the end support element and the side support elements for urging the side support elements into engagement with the opposite sides of the neck on loading of the support device with the neck of the subject supported on the end support element, and advantageously, the strengthening member co-operates with the first platform engaging element for urging the side support elements into engagement with the opposite sides of the neck on loading of the support device with the neck of the subject supported in the support element, and preferably, the strengthening member is of arcuate transverse cross-section, and advantageously, the transverse cross-section of the strengthening member defines a segment of a circle, and preferably, the segment of the circle defined by the transverse cross-section of the strengthening member extends an angular distance in the range of 90° to 130°, and advantageously, the resilience of the strengthening member is such as to substantially instantaneously return the support device to its unloaded state once a load has been removed therefrom, and preferably, the strengthening member is located adjacent a boundary between the first layer and the second layer, and advantageously, an air accommodating opening is provided extending through the central support element to accommodate air to a portion of the part of the body of the subject, and preferably, the air accommodating opening is adapted to accommodate a bony prominence extending from the portion of the head supported by the central support element, and advantageously, the platform engaging elements and the central support element define a concave surface when viewed from underneath, and preferably, the platform engaging elements extend downwardly from the central support element beneath the side support elements, and advantageously, the central support element is dished when viewed in plan from above, and preferably, the side support elements and the central support element define a concave surface when viewed from above.

223. A kit of parts for supporting a subject in a supine state on a support platform, the kit of parts comprising the head support device as claimed in claim 221.

224. A kit of parts as claimed in claim 223 further comprising an arm support device, the arm support device comprising an elongated central support element extending between a first end and a second end and between a pair of opposite spaced apart raised side support elements, a pair of spaced apart first platform engaging elements extending downwardly on respective opposite sides of the central support element towards the first end thereof, and a pair of spaced apart second platform engaging elements extending downwardly on respective opposite sides of the central support element towards the second end thereof, and at least one elongated resiliently deformable strengthening member located in and extending transversely of the central support element between the first platform engaging elements, the strengthening member co-operating with the central support element and the side support elements for urging the side support elements into engagement with respective opposite sides of an arm of the subject when the support device is in a loaded state with the central support element supporting the arm and for returning the support device to an unloaded state when the load is removed therefrom, and preferably, two spaced apart strengthening members are located in the central support element of the arm support device adjacent the respective opposite first and second ends of the central support element, and preferably, a pair of arm support devices are provided, and advantageously, the kit of parts further comprises a foot support device comprising a central support element extending between a first end and a second end, and a pair of raised side support elements located on respective opposite sides of the central support element, an end support element located adjacent the first end of the central support element for engaging a leg of the subject adjacent the ankle thereof with the heel of the foot of the subject supported on the central support element, a pair of spaced apart first platform engaging elements extending downwardly from the central support element adjacent the end support element, and an elongated resiliently deformable strengthening member located in the end support element extending transversely of the central support element between the first platform engaging elements, the strengthening member co-operating with the end support element and the side support elements for urging the side support elements into engagement with respective ankles of the leg of the subject when the foot support element is in a loaded state supporting a foot of the subject and for returning the support device to an unloaded state when the load is removed therefrom, and preferably, a foot engaging member extends upwardly from the second end of the central support element for engaging the sole of the foot of a subject, and at least one second platform engaging element extends downwardly from the central support element adjacent the second end thereof, the central support element co-operating with the foot engaging member for urging the foot engaging member into engagement with the sole of the foot of the subject when the foot support device is in the loaded state with the heel of the foot supported on the central support element, and advantageously, the central support element co-operates with the platform engaging elements for urging the foot engaging member into engagement with the sole of the foot of the subject, and preferably, a pair of spaced apart second platform engaging elements extend downwardly from the central support element on opposite sides thereof adjacent the second end thereof, and advantageously, a pair of foot support devices are provided, and preferably, the kit of parts further comprises a leg support device for supporting a leg of the subject adjacent the back of the knee thereof on the support platform, the leg support device comprising a central support element extending between a first end and a second end and between respective raised side support elements on respective opposite sides of the central support element, a pair of spaced apart first platform engaging elements extending downwardly from the central support element adjacent opposite sides thereof adjacent the first end thereof beneath the side support elements, and a pair of second platform engaging elements extending downwardly from the central support element adjacent opposite sides thereof adjacent the second end thereof, and an elongated resiliently deformable strengthening member located in and extending transversely of the central support element between the platform engaging elements, the strengthening member co-operating with the central support element and the side support elements for urging the side support elements into engagement with respective opposite sides of the leg of the subject adjacent the knee thereof when the leg support device is in a loaded state supporting the part of the leg and for returning the support device to the unloaded state when the load is removed therefrom, and advantageously, the strengthening member co-operates with at least one of the pairs of first and second platform engaging elements for urging the side support elements into engagement with the side of the leg adjacent the knee when the support device is in the loaded state, and preferably, a pair of leg support devices are provided, and advantageously, the kit of parts further comprises a trunk support device for supporting a part of the trunk of the body of the subject on the support platform, the trunk support device comprising a central support element extending between a first end and a second end and between respective opposite raised side support elements on respective opposite sides of the central support element, a pair of spaced apart platform engaging elements extending downwardly from the central support element on respective sides thereof, and an elongated resiliently deformable strengthening member located in and extending transversely of the central support element between the platform engaging elements, the strengthening member co-operating with the central support element and the side support elements for urging one of the side support elements into engagement with the back of the trunk between the spine of the trunk and one side thereof, and the other side support element into engagement with the adjacent side of the trunk when the support device is in a loaded state with a portion of the back of the trunk between the spine and the said side of the trunk supported on the central support element, and for returning the support device to the unloaded state when the load is removed therefrom, and preferably, the strengthening member co-operates with the platform engaging elements for urging the one of the side support elements into engagement with the adjacent side of the trunk of the subject, and advantageously, a pair of trunk support devices are provided, and preferably, each strengthening member of each support device is of arcuate transverse cross-section, and advantageously, the transverse cross-section of each strengthening member defines a segment of a circle, and preferably, the segment of the circle defined by the transverse cross-section of each strengthening member extends an angular distance in the range of 90° to 130°, and advantageously, an air accommodating opening is provided extending through the central support element of at least some of the support devices to accommodate air to a portion of the part of the body of the subject, and preferably, the air accommodating opening in the corresponding central support element is adapted to accommodate a bony prominence extending from the portion of the part of the body supported by the central support element, and advantageously, the central and side support elements and the platform engaging elements of the respective support devices are resilient.

225. A method for supporting a subject on a support platform comprising placing the respective support devices of the kit of parts as claimed in claim 223 on the platform with the platform engaging elements engaging the platform, and placing the head of the subject in the head support device with the back of the head resting on the central support element and the neck of the subject resting on the first end support element, placing the trunk support devices under the back of the subject with the trunk support devices supporting the back of the subject on respective opposite sides thereof, placing the leg support devices beneath the legs of the subject behind the knees thereof, placing the foot support devices beneath the respective heel bones of the subject with the heel bone of the subject supported on the respective central support elements of the foot support devices, placing the arm support devices beneath the arms of the subject with the arms supported on the central support elements of the arm support devices.
